(19) United States
(12) Patent Application Publication
(10) Pub. No.: US 2015/0294093 A1
(43) Pub. Date: Oct. 15, 2015

(54) MANAGEMENT SYSTEM, INFORMATION PROCESSING DEVICE, MANAGEMENT SERVER, CONTROL METHOD THEREFOR, AND PROGRAM

(71) Applicant: CANON KABUSHIKI KAISHA, Tokyo (JP)

(72) Inventor: Kenta Yabe, Kawasaki-shi (JP)

(21) Appl. No.: 14/681,268

(22) Filed: Apr. 8, 2015

(30) Foreign Application Priority Data
Apr. 11, 2014 (JP) 2014-081670

(51) Int. Cl. G06F 21/10; G06F 21/12

(52) U.S. Cl. CPC G06F 21/105; G06F 21/12; G06F 2221/0768

(57) ABSTRACT

When software as the object of issuance of license is software for which movement of license to another information processing device is prohibited or which is in dependence relationship with the software for which movement of license to the other information processing device is prohibited, the license is issued to which transfer prohibition information is attached indicating that movement of the license to the other information processing device is prohibited.

### BACKGROUND OF THE INVENTION

1. Field of the Invention

The present invention relates to management of license for utilizing software.

2. Description of the Related Art

Some of the latest multi-functional peripherals (hereafter referred to as “MFP”) are equipped with a platform for adding and extending the device function by installing application software (hereafter referred to as “application”).

The application is normally provided to the user for a fee. Thus, as a mechanism for preventing unauthorized use of the application by an indefinite number of users or on a number of MFPs not expected by the developer, the application is generally provided with a license-based mechanism.

For example, the application is encrypted using an encryption key generated by a license management server. The encrypted application can be installed in the MFP by being decrypted using a decryption key included in a license issued by the same license management server.

The license is normally issued by the license management server after the permitted MFP is identified. However, the license may be transferred (moved) to an MFP other than the MFP designated at the time of issuance of the license under specific conditions, such as in case of repurchasing an MFP or replacing a defective MFP (see Japanese Patent Application Laid-Open No. 2012-234525).

### SUMMARY OF THE INVENTION

The present invention provides a management system including a management server that manages software license utilizable in an information processing device, and one or more information processing devices. The management server includes an issuing unit that issues the software license to a designated information processing device, and a managing unit that manages the license issued by the issuing unit in association with the designated information processing device. The issuing unit issues the license to which transfer prohibition information is attached indicating that movement of the license to another information processing device is prohibited when the software as the object of issuance of license is software for which movement of the license to the other information processing device is prohibited, or which is in dependence relationship with the software for which movement of the license to the other information processing device is prohibited. The information processing device includes a utilizing unit that makes the software utilizable using the license issued in the management server, and a generating unit that invalidates the license on the information processing device and generates invalidation information indicating that the license is invalidated as a process for moving the license used for utilization of the software from the information processing device to the other information processing device, and a prohibiting unit that prohibits the process by the generating unit with respect to the license to which the transfer prohibition information is attached.

Further features of the present invention will become apparent from the following description of exemplary embodiments (with reference to the attached drawings).

### BRIEF DESCRIPTION OF THE DRAWINGS

FIG. 1 is a block diagram of an example of a management system according to the present invention.

FIG. 2 is a hardware configuration diagram of a license management server and a PC.

FIG. 3 is a hardware configuration diagram of an MFP.

FIG. 4 is a software configuration diagram of the license management server.

FIG. 5 is a software configuration diagram of the MFP.

FIGS. 6A to 6F are data configuration diagrams of data managed by the license management server.

FIGS. 7A to 7D are data configuration diagrams of data managed by the MFP.

FIGS. 8A and 8B are license data configuration diagrams.

FIGS. 9A and 9B are diagrams illustrating a license issuance screen.

FIG. 10 is a flowchart of a license issuance process according to a first exemplary embodiment.

FIGS. 11A and 11B are diagrams illustrating a license installation screen.

FIG. 12 is a flowchart of a license installation process.

FIGS. 13A and 13B are diagrams illustrating an invalidation license for transfer issuance screen.

FIG. 14 is a flowchart of an invalidation license for transfer issuance screen display process.

FIGS. 15A and 15B are diagrams illustrating a transfer license issuance screen according to the first exemplary embodiment.

FIG. 16 is a flowchart of a transfer license issuance screen presentation process.

FIG. 17 is a diagram illustrating a transfer license issuance screen according to the second exemplary embodiment.

FIGS. 18A and 18B are data configuration diagrams of data managed by the license management server according to the second exemplary embodiment.

FIG. 19 is a flowchart of a license number additional issuance enabling process.

FIG. 20 is a flowchart of the license issuance process according to the second exemplary embodiment.

### DESCRIPTION OF THE EMBODIMENTS

The license management server cannot issue license to the MFP as a transfer destination until it is confirmed that application and license have been deleted from the MFP as a transfer source in order to prevent unauthorized utilization. Thus, the transfer source MFP, when executing a license transfer operation, outputs proof of deletion information as the result of deletion of the application and its license. The proof of deletion information will be referred to as “invalidation license for transfer”. The license management server is enabled to issue license to a different MFP only after receiving the invalidation license for transfer.

When the license management server manages the license, the application rendered utilizable by the license and the MFP are associated with each other on a one-to-one basis. The license sales mode for the application thus managed is referred to as a “single-item merchandise”. Normally, a user who has purchased a single-item merchandise acquires, together with the application, a license number for use in issuing license from the license management server. When installing the application in the MFP, the user transmits identification information of the object MFP, such as a serial number of the MFP, and the license number to the license management server. The license management server then issues a license corresponding to the application which is utilizable only in the MFP with the received serial number, and transmits the license to the user.

As the number of utilized applications increases, the user needs to manage the respective license numbers. In a license sales mode for eliminating this need, a plurality of applications and the MFP are managed on a many-to-one basis. The license sales mode of the application thus managed is referred to as a “complex merchandise”. In the case of complex merchandise, a plurality of applications is managed using a common license number of the applications, and the user acquires and manages the common license number. The license management server associates the identification information of one MFP with the common license number of all of the applications belonging to the complex merchandise, and issues a license. Thus, the user can easily acquire license without using different license numbers among the applications belonging to the complex merchandise.

In the case of complex merchandise, the license management server manages the license by associating all of the belonging applications with a single MFP. Thus, it is not permitted to utilize the applications belonging to the complex merchandise across a plurality of MFPs. For example, when two applications belong to a complex merchandise, it is not allowed to issue a license for utilizing one of the applications in each of two MFPs. For this reason, in the case of a complex merchandise, when its license is transferred to different MFPs, it is necessary to issue a invalidation license for transfer with respect to all of the issued licenses, and then execute a license transfer operation all at once.

However, the applications may include those that are transferrable between MFPs and those that are not. If the application extends a basic operation of the MFP, license transfer is allowed because the transfer would not affect the operation of the transfer source MFP. This is the case, for example, for an application that provides added-value to the print function, such as a copy-forgery-prohibit-pattern print application.

Meanwhile, in the case of an application that controls a basic operation of the MFP, such as the number of continuous copying on the MFP, if the license is transferred, the transfer source MFP would not be able to be operated. For such an application, transfer operation is prohibited on the MFP side.

When the applications constituting the complex merchandise include applications that can be moved between MFPs and applications that cannot, an invalidation license for transfer cannot be issued for all of the applications. Namely, for such a complex merchandise, the license management server cannot re-issue the license for the transfer destination MFP.

The MFP is not aware whether the installed license applications are included in a complex merchandise. Thus, it has been possible to execute a transfer operation on the transfer source MFP, specifically an operation for deleting an application and its license. However, even if such transfer operation is performed and an application that constitutes a complex merchandise and that can be moved between MFPs is deleted, the license for that application cannot be transferred to another MFP. Accordingly, such transfer operation is totally wasteful for the user.

The present invention has been made to overcome the above-described problems, and an object of the present invention is to provide a mechanism for preventing a useless operation by the user with respect to the license for an application for which license transfer is not enabled.

In the following, various modes for carrying out the present invention will be described with reference to the drawings.

### First Exemplary Embodiment

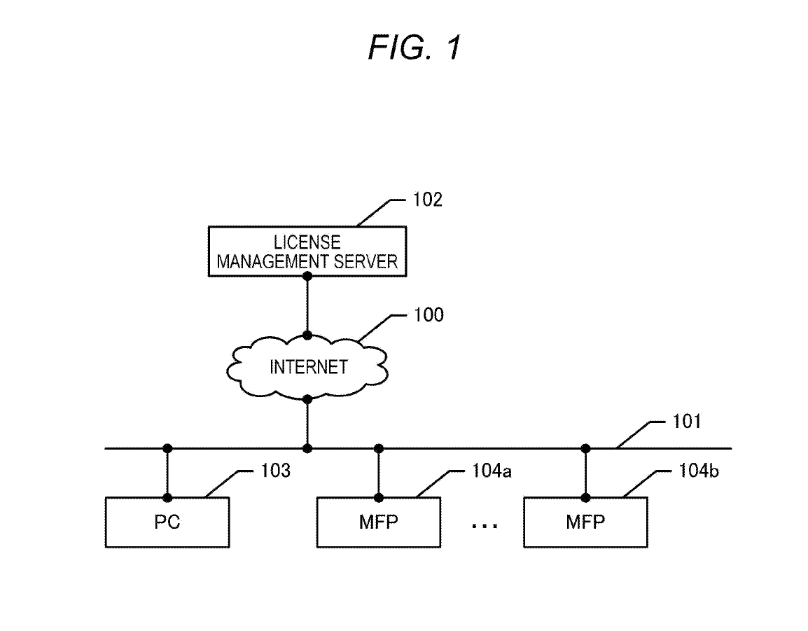

FIG. 1 is a block diagram of the overall configuration of a management system as an example of the present invention.

An Internet 100 is a network that connects a license management server 102, a personal computer (PC) 103, and multi-functional peripherals (MFP) 104, among the constituent elements shown in FIG. 1. In the example of FIG. 1, one PC and one MFP are connected to a single license management server. However, the number of the PCs and MFPs is not limited to one and may be an arbitrary number of two or more.

A local area network (LAN) 101 is a network that connects, among other constituent elements shown in FIG. 1, the PC 103 and the MFPs 104 (such as 104a and 104b). In the following, the MFPs 104a and 104b may be simply referred to as the MFP 104. In the example of FIG. 1, two MFPs are connected to one PC. However, the numbers of the PCs and MFPs may be each an arbitrary number of one or more.

The license management server 102 is an Internet application server that issues a license for software installed in the PC (hereafter referred to as “PC software”) and software installed in the MFP (hereafter referred to as “MFP software”). The license management server 102 may include a single computer or a plurality of computers.

The PC 103 is an information processing device, such as a personal computer. The PC 103 communicates with the MFP 104 via the LAN 101. The PC 103 also communicates with the license management server 102 via the Internet 100.

The MFP 104 is an image forming device including scanner function, copy function, print function, and communication function and the like. The MFP 104 communicates with the PC 103 via the LAN 101. The MFP 104 communicates with the license management server 102 via the Internet 100.

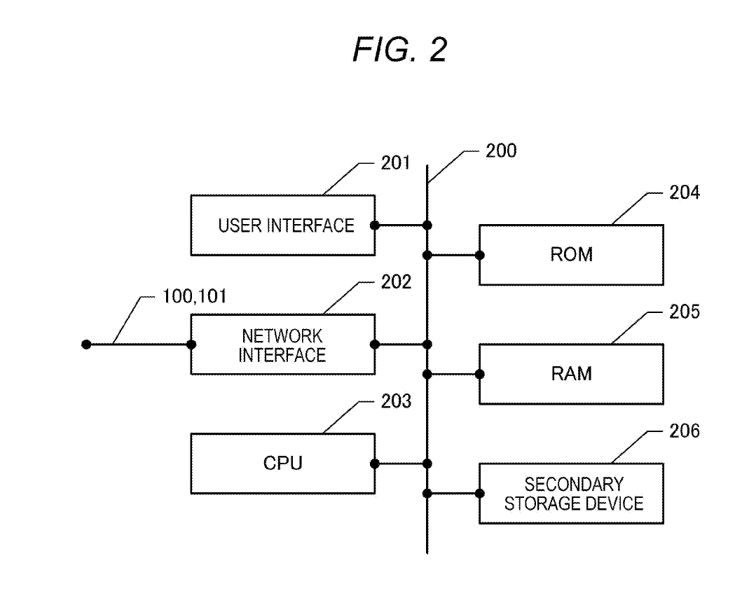

FIG. 2 is a block diagram of a hardware configuration of the license management server 102 and the PC 103.

A system bus 200 mutually connects various units of the information processing device. A user interface 201 includes hardware for the input and output of information using a display, a keyboard, a mouse and the like. A computer not equipped with such hardware may be connected and operated from another computer using remote desktop technology, for example.

A network interface 202 includes hardware for communicating with other computers or network devices by connecting to a network, such as the Internet 100 or the LAN 101. A CPU 203 executes a program read from a ROM 204, a RAM 205, or a secondary storage device 206 to realize various functions. The CPU 203 may control various constituent elements connected via the system bus 200 either directly or indirectly.

The ROM 204 is a read-only storage device in which an embedded program, such as BIOS, and data are recorded. The RAM 205 is a temporary memory region utilized as a work area for operation of the CPU 203. The secondary storage device 206 includes an external storage device such as represented by a hard disk drive (HDD) or a solid state drive (SSD) in which an OS, which is basic software, and other software modules are stored.

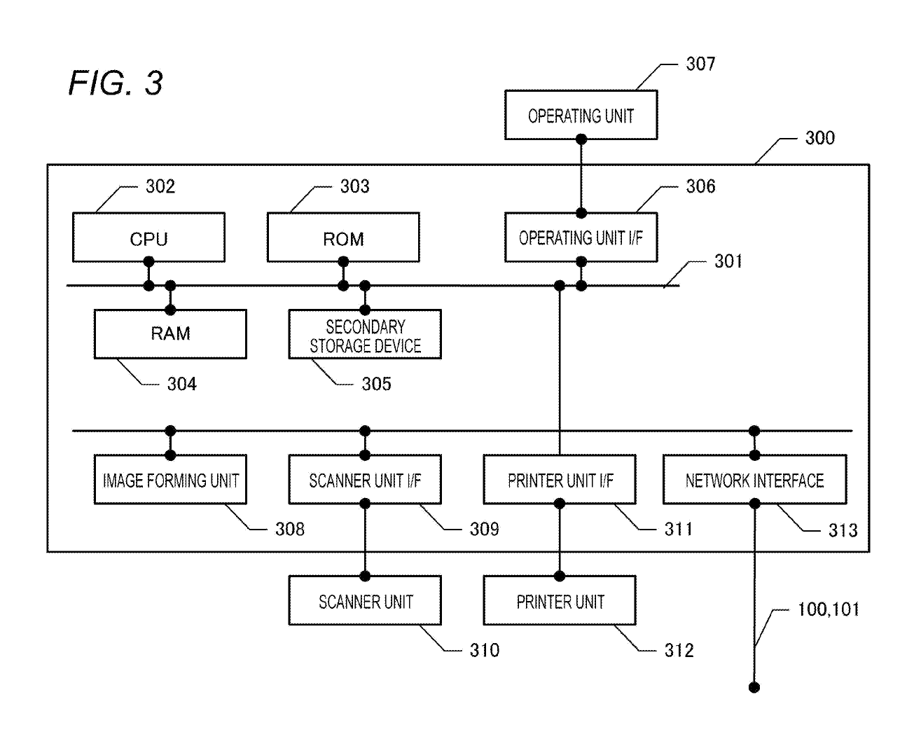

FIG. 3 is a block diagram of a hardware configuration of the MFP 104.

A controller 300 is electrically connected to an operating unit 307, a scanner unit 310, and a printer unit 312. The controller 300 is also connected to the Internet 100 and the LAN 101 via a network interface 313. Thus, the controller 300 is capable of communication based on a communication protocol, such as TCP/IP.

The system bus 301 mutually connects the various constituent elements of the controller 300. A CPU 302 generally controls access to each PC 103 and each MFP 104 being connected via the LAN 101 and access from other devices on the basis of a control program and the like stored in the ROM 303. The CPU 302 also controls, directly or indirectly, the various constituent elements of the controller 300 connected via the system bus 301. The control implemented by the CPU 302 includes execution of a program for implementing a flowchart of the present invention which will be described below.

The ROM 303 is a read-only storage device in which a device boot program is stored. A RAM 304 provides a work area for the operation of the CPU 302 and a main storage device utilized for temporary storage of image data. The RAM 304 may also be utilized as a temporary storage for reading a software module for implementing the present exemplary embodiment. A secondary storage device 305 is an auxiliary storage device capable of storing, e.g., system software and image data. The secondary storage device 305 is a storage device such as represented by a HDD or a SSD, for example.

An operating unit I/F 306 is an interface unit for connecting the system bus 301 and the operating unit 307. The operating unit I/F 306 receives image data for display on the operating unit 307 from the system bus 301 and outputs the data to the operating unit 307. The operating unit I/F 306 also outputs information input from the operating unit 307 onto the system bus 301.

The operating unit 307 includes an input and output device, such as a touch panel display. The operating unit 307 has the function of displaying information to the user utilizing the MFP 104 and receiving an input from the user. A network I/F 313 is connected to the Internet 100, the LAN 101, and the system bus 301 to perform input and output of information.

An image forming unit 308 performs image data orientation conversion, image compression, decompression processing and the like. The image forming unit 308 may also be configured to combine image data stored in the secondary storage device 305 to produce a single image.

A scanner unit I/F 309 performs correction, processing, and editing with respect to image data received from the scanner unit 310. The scanner unit 310 is an image input device that reads an image of an original document placed on an original document scanner table (not shown) of the MFP 104 to create image data.

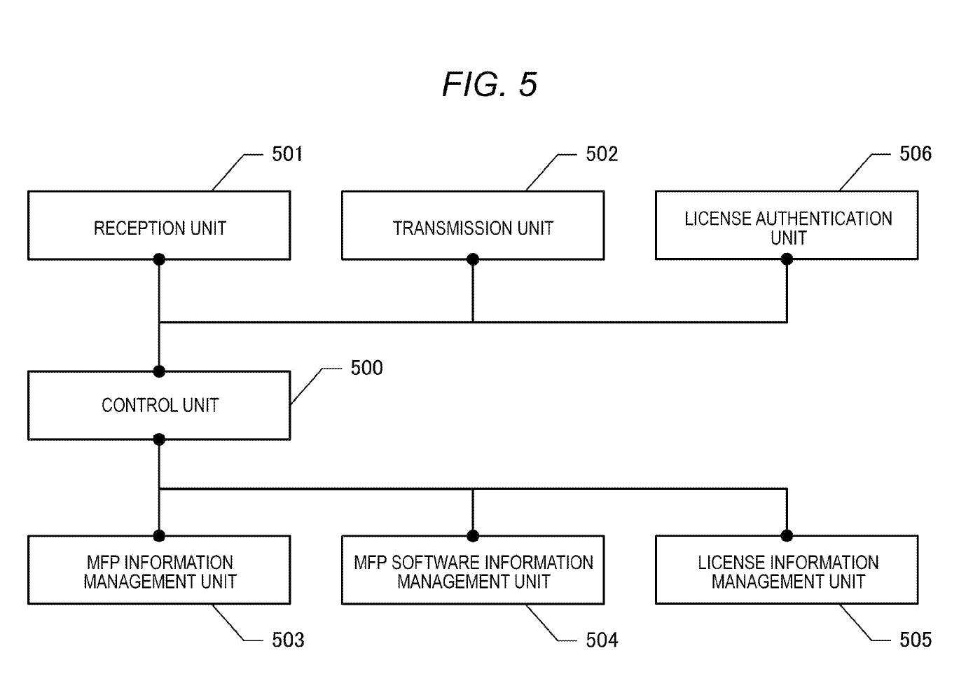

A printer unit I/F 311 receives image data sent from the image forming unit 308, and subjects the image data to image formation with reference to attribute data accompanying the image data. The image data after image formation is output to the printer unit 312. The printer unit 312 is an image output device that renders the image data received from the controller 300 via the printer unit I/F 311 into a printed image on a sheet. The printer unit 312 determines the speed at which the printed image is formed on the sheet based on the image data in accordance with a continuous copy speed value managed by a MFP information management unit 503, which will be described below (FIG. 5).

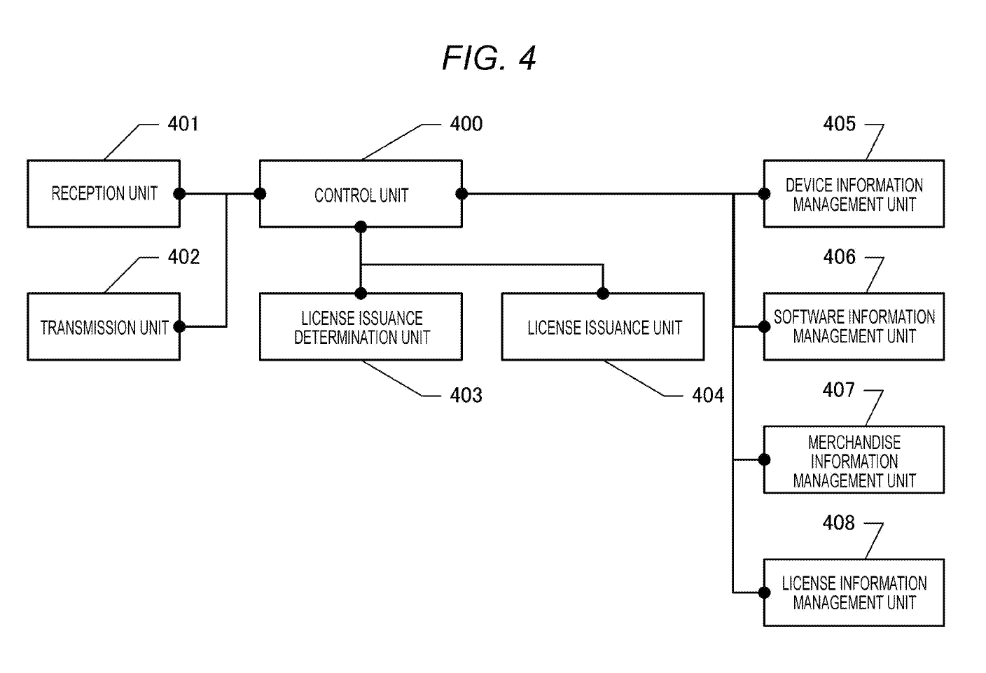

FIG. 4 is a block diagram of a configuration of software modules of the license management server 102. The software modules are realized by the CPU 203 executing a program stored in the secondary storage device 206 of the license management server 102.

A control unit 400 controls the license management server 102 as a whole and issues instructions or perform management with respect to various constituent elements of the software modules. A reception unit 401 performs a process of receiving a license issuing request from the PC 103 connected via the Internet 100. The license issuing request refers to data transmitted from the PC 103 to the license management server 102 when acquiring a license necessary for installing MFP software in the MFP 104. The license issuing request includes a license number corresponding to the installed MFP software, and a device number uniquely identifying the MFP as the object of installation.

The reception unit 401 also similarly performs a process of receiving a transfer license issuance request from the PC 103. The transfer license issuance request is data (movement request) transmitted from the PC 103 to the license management server 102 when a license already issued to a specific MFP is invalidated and newly issued (moved) to another MFP. The transfer license issuance request includes an invalidation license for transfer acquired from the transfer source (movement origin) MFP, and a device number uniquely identifying the transfer destination (movement destination) MFP.

A transmission unit 402 transmits a license to the PC 103 connected via the Internet 100. A license issuance determination unit 403 determines whether, under the instruction of the control unit 400, each of the license issuing request and the transfer license issuance request received by the reception unit 401 is a valid request for issuing the corresponding license. During the determination, the license issuance determination unit 403 acquires appropriate information from a device information management unit 405, a software information management unit 406, a merchandise information management unit 407, and a license information management unit 408. The determination process executed by the license issuance determination unit 403 according to the present exemplary embodiment will be described later. The license issuance determination unit 403 delivers a result of the determination process to the control unit 400. A license issuance unit 404 issues a license when the result of the determination process in the license issuance determination unit 403 is true, under the instruction of the control unit 400.

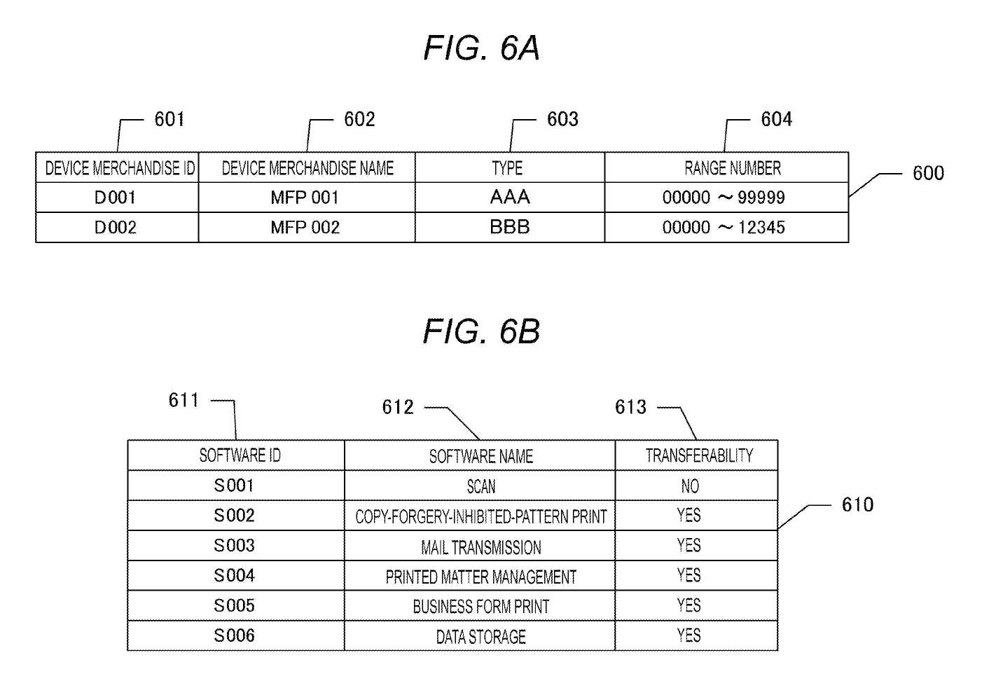

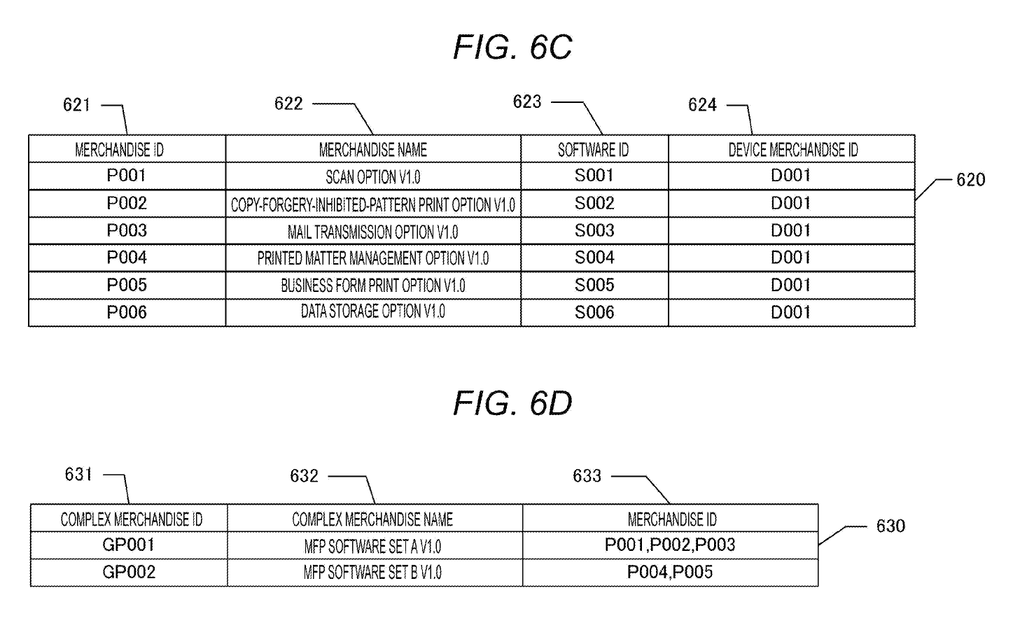

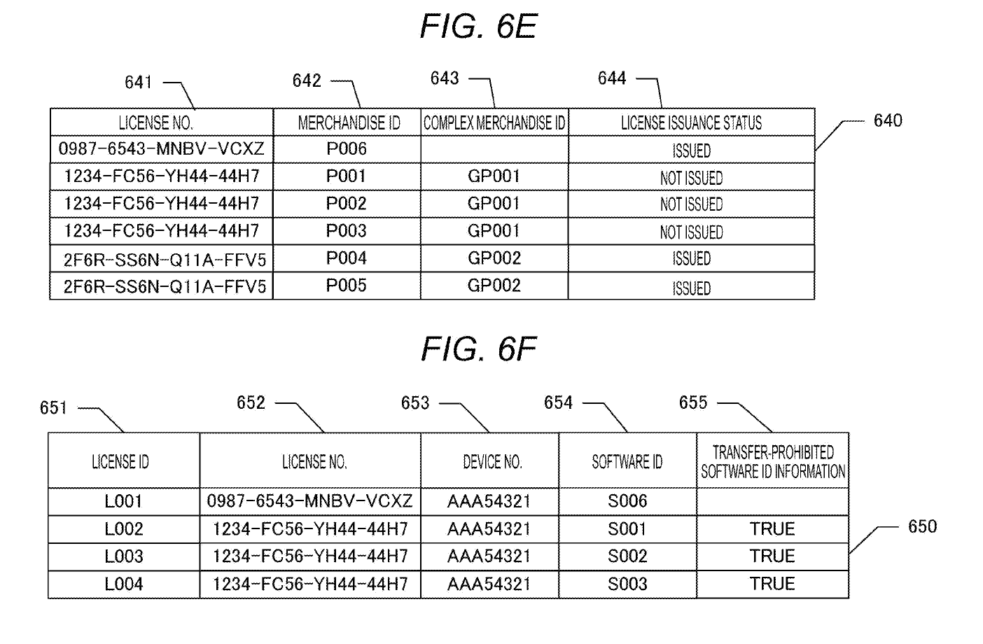

The device information management unit 405 manages device information stored in the secondary storage device 206 under the instruction of the control unit 400. The device information includes various information for identifying the MFP as the object of installation of software and license. The device information is managed using a device merchandise information management table 600 (FIGS. 6A to 6F).

The software information management unit 406 manages software information stored in the secondary storage device 206 under the instruction of the control unit 400. The software information includes various information for identifying the MFP software installed in the MFP. The MFP software information is managed using a software information management table 610 (FIG. 6A to 6F).

The merchandise information management unit 407 manages MFP software merchandise information stored in the secondary storage device 206 under the instruction of the control unit 400. The MFP software merchandise information constitutes a unit of information for the issuance of the license number and license, and includes information associating the MFP software information with the device information. The MFP software merchandise information is managed using a merchandise information management table 620 and a complex merchandise information management table 630 (FIGS. 6A to 6F).

The license information management unit 408 manages license merchandise information stored in the secondary storage device 206 under the instruction of the control unit 400. The license information includes various information for identifying the license number and license. The license information is managed using a license number management table 640 and a license management table 650 (FIGS. 6A to 6F).

FIG. 5 is a block diagram of a configuration of software modules of the MFP 104. The software modules are realized by the CPU 302 executing a program stored in the secondary storage device 305 of the MFP 104.

The control unit 500 controls the MFP 104 as a whole, and issues instructions to or manages the various constituent elements of the software module. A reception unit 501 performs a process of receiving a license installation request from the PC 103 connected via the LAN 101, or a license installation request from the operating unit 307 of the MFP 104. The license installation request received by the reception unit 501 is processed by the license authentication unit 506 under the instruction of the control unit 500. The license installation request is a request transmitted by the user of the MFP 104 when making the MFP software executable by the MFP 104. The license installation request includes the MFP software and a license 800 or license 810 which will be described below.

The reception unit 501 performs a process of receiving a license invalidation request from the PC 103 connected via the LAN 101, or a license invalidation request from the operating unit 307 of the MFP 104. The license invalidation request received by the reception unit 501 is processed by the license authentication unit 506 under the instruction of the control unit 500. The license invalidation request refers to a request transmitted when performing license transfer. The license invalidation request is a request transmitted by the user of the MFP 104 when placing the MFP software and license which are in executable state in the MFP 104 in unusable state.

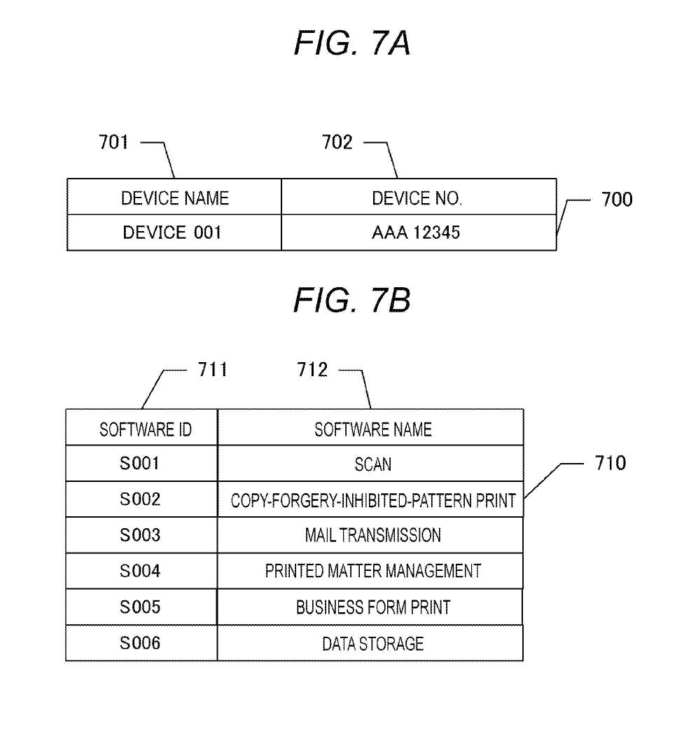

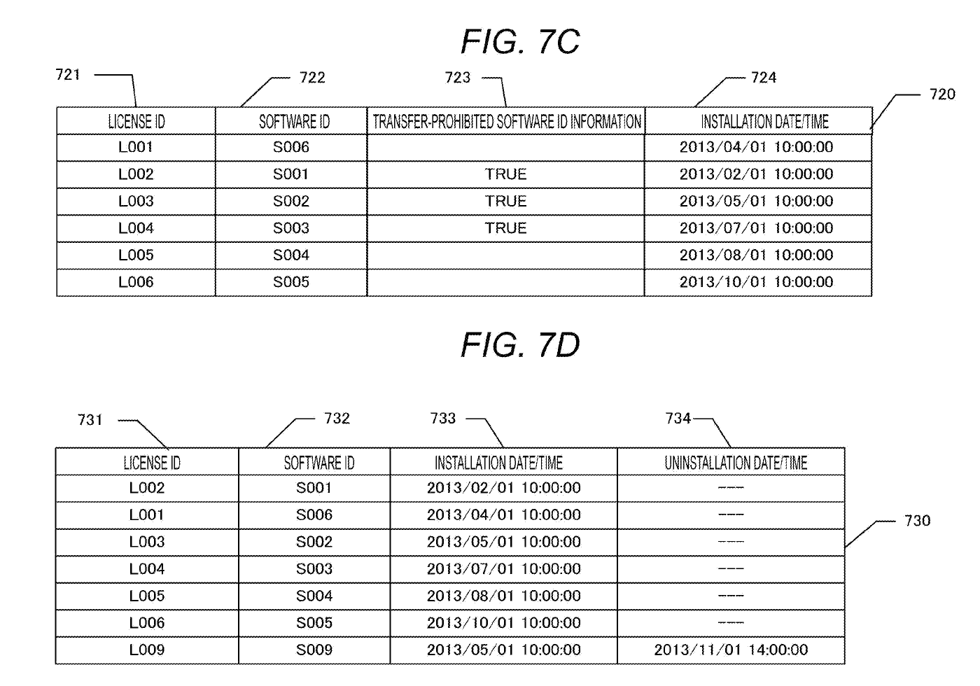

When the reception unit 501 receives the license invalidation request, first the license authentication unit 506 deletes license information from the respective data in the license information management table 720 (FIGS. 7A to 7D). The license authentication unit 506 then issues an invalidation license for transfer, and returns the invalidation license for transfer to the user of the MFP 104 via the transmission unit 502 as a response to the license invalidation request. By this series of processes, the relevant MFP software is rendered inexecutable from the MFP 104, and the license information is also deleted. The invalidation license for transfer includes data proving that the license information of the MFP software that has been installed in the MFP 104 has been deleted, and that the MFP software is now in unusable state, and has the same configuration as the license 800.

In response to a transfer license issuance request, the license management server 102, by reading the information of the invalidation license for transfer included in the transfer license issuance request, corrects the license information that has been generated and registered when a license was issued to the MFP in the past (the details will be described later). In this way, a transfer license can be newly issued to the transfer destination MFP while data consistency is maintained between the license management server 102 and the MFP 104.

The transmission unit 502 transmits the result of processing of the license installation request and license invalidation request in the license authentication unit 506 to the PC 103 or the operating unit 307 of the MFP 104 connected via the LAN 101.

The MFP information management unit 503 manages the MFP information stored in the secondary storage device 305 under the instruction of the control unit 500. The MFP information includes various setting information necessary for uniquely identifying the MFP. The MFP information is managed using a MFP information management table 700 (FIGS. 7A to 7D).

The MFP software information management unit 504 manages MFP software information installed in an MFP that is stored in the secondary storage device 305, under the instruction of the control unit 500. The MFP software information includes various information concerning the software installed in the MFP, and information identifying whether the license to which the software corresponds is installed. The MFP software information is managed using a MFP software information management table 710 (FIGS. 7A to 7D).

A license information management unit 505 manages, under the instruction of the control unit 500, information related to the license corresponding to the software for an extended function installed in the MFP that is stored in the secondary storage device 305. The information related to the license managed by the license information management unit 505 has two types. One is license information for managing data of each of licenses 800 and 810 included in the license installation request received by the reception unit 501, in association with information about the date/time of reception of the license installation request. The license information is managed using a license information management table 720 (FIGS. 7A to 7D). The other is a license installation history for managing the license information in association with information about the date/time of processing of the license installation request received by the reception unit 501, or information about the date/time of processing of the license invalidation request. The license installation history is managed using a license installation history management table 730 (FIGS. 7A to 7D).

The license authentication unit 506 processes the license issued by the license management server 102 so that the software corresponding to the MFP 104 can be used. The license authentication unit 506 also executes a license invalidation process necessary for transferring a license installed in an MFP to a different MFP. The license authentication process and the license invalidation process in the MFP will be described later.

FIGS. 6A to 6F illustrate the data structure of the information managed in the device information management unit 405, the software information management unit 406, the merchandise information management unit 407, and the license information management unit 408 of the license management server 102 in table format.

The device merchandise information management table 600 shown in FIG. 6A is a table for managing the device merchandise information in the device information management unit 405. The device merchandise information defines various data as a whole concerning apparatus model information of MFPs produced and shipped from a factory. The device merchandise information is registered in the license management server 102 before the MFP is produced in the factory. The MFP is shipped with various data of the device merchandise information set, during production in the factory, in the MFP information management table 700 (FIGS. 7A to 7D) stored in the secondary storage device 305 of the MFP. For example, various data in a type column 603 and a range number column 604 are set in corresponding columns in the MFP information management table 700.

The device merchandise information management table 600 includes a device merchandise ID column 601; a device merchandise name column 602; a type column 603; and a range number column 604. The device merchandise ID column 601 is a column storing a device merchandise ID providing information for uniquely identifying device merchandise information. The device merchandise name column 602 is a column storing a merchandise name of the device merchandise. The type column 603 and the range number column 604 store values of information defining ranges of possible values as a device number 653 (FIG. 6F) for uniquely identifying the MFP. The device number 653 is, for example, a value made up of a total of eight characters including three letters of the alphabet to which five numerical characters are added. The type column 603 is a column storing values defining the initial three letters of the alphabet of the values making up the device number 653. The range number column 604 is a column storing values defining a possible range of the last five numerical characters of the values making up the device number 653. For example, when “AAA” is stored in the type column 603 and “00000 to 99999” is stored in the range number column 604 with respect to a certain device merchandise ID, this means that the device number may take a total of 100,000 ways of device numbers from AAA00000 to AAA99999.

The software information management table 610 shown in FIG. 6B is a table for managing information of MFP software that becomes installable with the license issued by the license management server 102 in the software information management unit 406. The software information management table 610 includes a software ID column 611, a software name column 612, and a transferability column 613. The various data in the software information management table 610 are registered in the license management server at an arbitrary timing of development of MFP software.

The software ID column 611 is a column storing the software ID as the information for uniquely identifying the MFP software. The software name column 612 is a column storing the name of the MFP software. The transferability column 613 is a column storing information indicating whether MFP software, after once having been installed in the MFP, can be installed in a different MFP. When the MFP software is software that extends the function of the MFP and would not adversely affect the operation of the MFP if transferred, “Yes” is stored in the transferability column 613. When the MFP software is software of a function that controls the basic operation of the MFP and would adversely affect the operation of the MFP if transferred, “No” is stored in the transferability column 613.

The merchandise information management table 620 shown in FIG. 6C is a table for managing, in the merchandise information management unit 407, the single-item merchandise information of MFP software that becomes installable with the license issued by the license management server 102. The merchandise information management table 620 includes a merchandise ID column 621, a merchandise name column 622, a software ID column 623, and a device merchandise ID column 624. In the license management server 102, issuance and management of license is performed in units of the single-item merchandise information managed herein or the complex merchandise information managed using the complex merchandise information management table 630 (FIG. 6C), which will be described later. To the user of the MFP software, sales are conducted in the merchandise information unit basis. The complex merchandise must utilize all of belonging applications in a single MFP, and the applications belonging to the complex merchandise are not permitted to be utilized across a plurality of MFPs. In this way, the applications belonging to the complex merchandise have a dependence relationship.

The merchandise ID column 621 is a column storing a merchandise ID as information for uniquely identifying the merchandise information. The merchandise name column 622 is a column storing a merchandise name of the MFP software. The software ID column 623 is a column storing a software ID of the MFP software corresponding to the merchandise. The value stored in the software ID column 623 is the value in the software ID column 611 of the software information management table 610. The device merchandise ID column 624 is a column storing a device merchandise ID for identifying the MFP in which the MFP software corresponding to the merchandise is installable. The MFP software corresponding to a merchandise can be installed only in the device merchandise that corresponds to the value stored herein and that is managed in the device merchandise information management table 600.

The complex merchandise information management table 630 shown in FIG. 6D is a table for managing the complex merchandise information of the MFP software that becomes installable with the license issued by the license management server 102 in the merchandise information management unit 407. The complex merchandise information management table 630 includes a complex merchandise ID column 631, a complex merchandise name column 632, and a merchandise ID column 633.

The complex merchandise ID column 631 is a column storing a complex merchandise ID as information for uniquely identifying the complex merchandise information. The complex merchandise name column 632 is a column storing a complex merchandise name of the MFP software. The merchandise ID column 633 is a column storing a merchandise ID of single-item information constituting a complex merchandise. A license for MFP software relevant to the merchandise ID stored herein becomes issuable with a single license number allocated to the complex merchandise.

The license number management table 640 shown in FIG. 6E is a table for managing information of license number in the license information management unit 408. The license number is information issued by the license management server 102. The license number is issued in advance, and normally distributed to the user of MFP software together with the MFP software. The user of the MFP software transmits a license issuing request including the license number from the PC 103 to the license management server 102, and acquires a license corresponding to the MFP software. A series of flow for the user of the MFP software to acquire the license will be described later. Specifically, the license number is used for issuing the license. The license number management table 640 includes a license number column 641, a merchandise ID column 642, a complex merchandise ID column 643, and a license issuing status column 644, with the relevant information being associated with each other.

The license number column 641 is a column storing a license number which is an arbitrary value for uniquely identifying the merchandise managed in the merchandise information management table 620, or a complex merchandise managed in the complex merchandise information management table 630. The license number is not limited to any particular format as long as the number is a unique value. In the present exemplary embodiment, the license number is a value consisting of four strings of four-digit characters combining any of the 26 letters of the alphabet and ten numerical characters. In the case of the license number for a complex merchandise, a common number is used when a license for all of MFP software corresponding to the value of the merchandise ID stored in the merchandise ID column 633 of the complex merchandise information is issued.

The merchandise ID column 642 is a column storing the merchandise ID of the merchandise information corresponding to the license number. Specifically, the values in the merchandise ID column 621 and the merchandise ID column 633 are stored in the merchandise ID column 642. The complex merchandise ID column 643 is a column storing a relevant complex merchandise ID when the merchandise information corresponding to the license number is included as an element of the complex merchandise. Specifically, in the complex merchandise ID column 643, there is stored the value of the complex merchandise ID column 631 of the complex merchandise information that includes the value of the merchandise ID column 642 in the merchandise ID column 633 of the complex merchandise information management table 630.

In the license issuing status column 644, there is stored a value indicating the state of whether the license management server 102 has issued a license for the MFP software related to merchandise information. If the license management server 102 has issued license to the user, a value “issued” is stored in the license issuing status column 644. If the license management server 102 has not issued license to the user, a value “not issued” is stored in the license issuing status column 644. Of the data registered in the license number management table 640, all of the values in the license number column 641 of data with corresponding values in the complex merchandise ID column 643 are identical.

In FIG. 6F, the license management table 650 is a table for managing information of the license issued by the license management server 102 in the license information management unit 408. The license management table 650 includes a license ID column 651, a license number column 652, a device number column 653, a software ID column 654, and a transfer-prohibited software identification information column 655, with the relevant information being associated with each other. The various data managed in the license management table 650 are registered when the license management server 102 received a license issuing request from the PC 103 and has issued a license. The flow of the issuance of license will be described later.

In the license ID column 651, an arbitrary value for uniquely identifying the license issued by the license management server 102 is stored. The license number column 652 is a column storing the license number included in the license issuing request received by the license management server 102. The device number column 653 is a column storing the device number included in the license issuing request received by the license management server 102. The software ID column 654 is a column storing the software ID of software information related to merchandise information corresponding to the license number received by the license management server 102. The transfer-prohibited software identification information column 655 is a column storing information identifying if the merchandise information corresponding to the license number received by the license management server 102 is that of a complex merchandise including a transfer-prohibited software merchandise as an element. When the complex merchandise includes a transfer-prohibited software merchandise as an element, a value “TRUE” is stored in the transfer-prohibited software identification information column 655. Otherwise, no value is stored.

FIGS. 7A to 7D illustrate the data structure of various information managed in the MFP information management unit 503, the MFP software information management unit 504, and the license information management unit 505 of the MFP 104 in table format.

In FIG. 7A, a MFP information management table 700 is a table for managing information concerning the device of the MFP 104 in the MFP information management unit 503. The MFP information management table 700 includes a device name column 701 and a device number column 702.

The device name column 701 is a column storing a device name set by the user of the MFP 104. The device number column 702 is a column storing a device number for uniquely identifying the MFP 104. The device number is stored at the time of factory shipping, and is a value which is non-modifiable by the user of the MFP 104.

In FIG. 7B, the MFP software information management table 710 is a table for managing information about the software installed in the MFP 104 in the MFP software information management unit 504. The MFP software information management table 710 includes a software ID column 711 and a software name column 712. Various data in the MFP software information management table 710 are registered each time MFP software and its corresponding license are installed in the MFP 104.

The software ID column 711 is a column storing a software ID for uniquely identifying MFP software. The software name column 712 is a column storing a software name of MFP software.

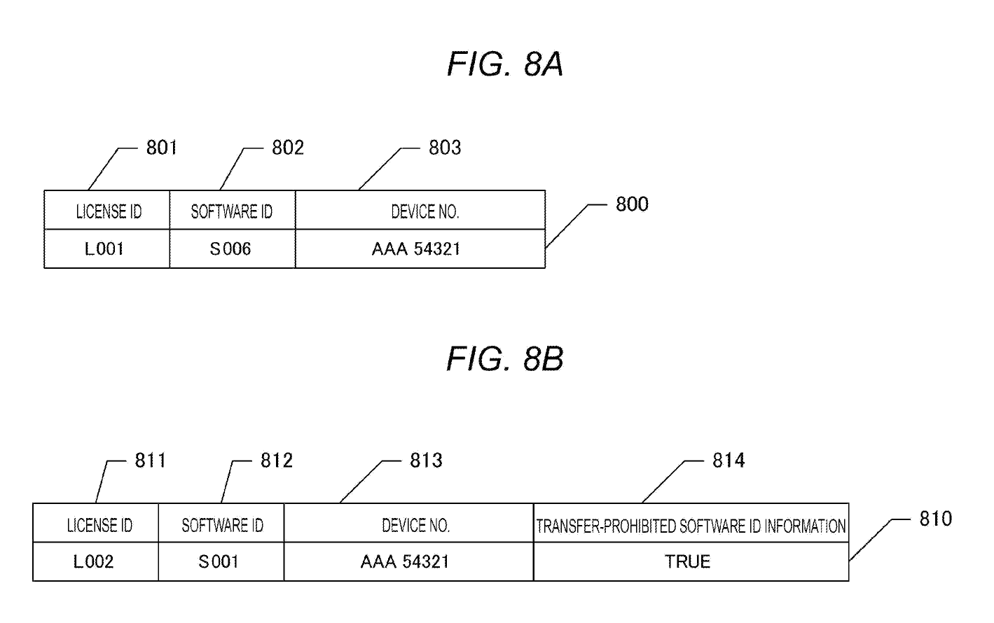

In FIG. 7C, the license information management table 720 is a table for managing information about the license installed in the MFP 104 in the license information management unit 505. The table is used for managing various data of license 800 (FIGS. 8A and 8B), which will be described later, in association with information about the date/time of processing of the license installation request. The license information management table 720 includes a license ID column 721, a software ID column 722, a transfer-prohibited software identification information column 723, and an installation date/time column 724. The various data in the license information management table 720 are registered at the time of installation of license.

In the license ID column 721, there is stored a value for uniquely identifying the license installed in the MFP 104, which is the value of the license ID column 651 corresponding to a software merchandise at the time of installation of the license. The software ID column 722 is a column storing the value for identifying the MFP software installed together with the license. The transfer-prohibited software identification information column 723 is a column storing the value of a transfer-prohibited software identification information column 814 of the license 810. The installation date/time column 724 is a column storing the date/time of installation of license corresponding to the license ID.

In FIG. 7D, a license installation history management table 730 is a table for managing information about the license installed and uninstalled in the MFP 104 in the license information management unit 505. The table is a table for managing various data of the license 800 (FIGS. 8A and 8B), which will be described later, in association with information about the date/time of processing of the license installation request, or information about the date/time of processing of an invalidation license issuing request. The license installation history management table 730 includes a license ID column 731, a software ID column 732, an installation date/time column 733, and an uninstallation date/time column 734. Various data of the license installation history management table 730 are registered at the time of installation and uninstallation of the license.

In the license ID column 731, there is stored a value for uniquely identifying the license installed in the MFP 104, which is the value of the license ID column 651 corresponding to a software merchandise at the time of installation of the license. The software ID column 732 is a column storing the value for identifying MFP software activated by the installation of license. The installation date/time column 733 is a column storing the date/time of installation of license corresponding to the license ID. The uninstallation date/time column 734 is a column storing the date/time of uninstallation of the license corresponding to the license ID.

FIGS. 8A and 8B illustrate the data structure in table format of license of which installation is performed in the license authentication unit 506 of the MFP 104. The license 800 and the license 810 (FIG. 8B) of a complex merchandise including a transfer-prohibited software merchandise are issued in the license issuance unit 404 of the license management server 102.

In FIG. 8A, the license 800 includes a license ID column 801, a software ID column 802, and a device number column 803. In the license ID column 801, there is stored a value for uniquely identifying the license which is the value of the license ID column 651 corresponding to the software merchandise. In the software ID column 802, there is stored a value for identifying the MFP software corresponding to the software merchandise. The device number column 803 is a column storing a device number identifying the MFP in which license can be installed.

In FIG. 8B, a license 810 of a complex merchandise including a transfer-prohibited software merchandise includes a license ID column 811, a software ID column 812, a device number column 813, and a transfer-prohibited software identification information column 814. Description of the license ID column 811, the software ID column 812, and the device number column 813 will be omitted as they are similar to the license ID column 801, the software ID column 802, and the device number column 803, respectively.

The transfer-prohibited software identification information column 814 is a column storing a value identifying that the MFP software merchandise as the object of issuance of license is a complex merchandise and includes, as one of constituent elements, a MFP software merchandise of which transfer is prohibited. Normally, the value “TRUE” is stored in the transfer-prohibited software identification information column 814. Even when the MFP software merchandise as the object of issuance of license is a complex merchandise, if the merchandise does not include a transfer-prohibited MFP software merchandise as a constituent element, the issued license has the data structure of the license 800. While in the present exemplary embodiment the data structure is shown in table format, the method of realizing the license issued in the license management server 102 may take various formats, such as binary file format.

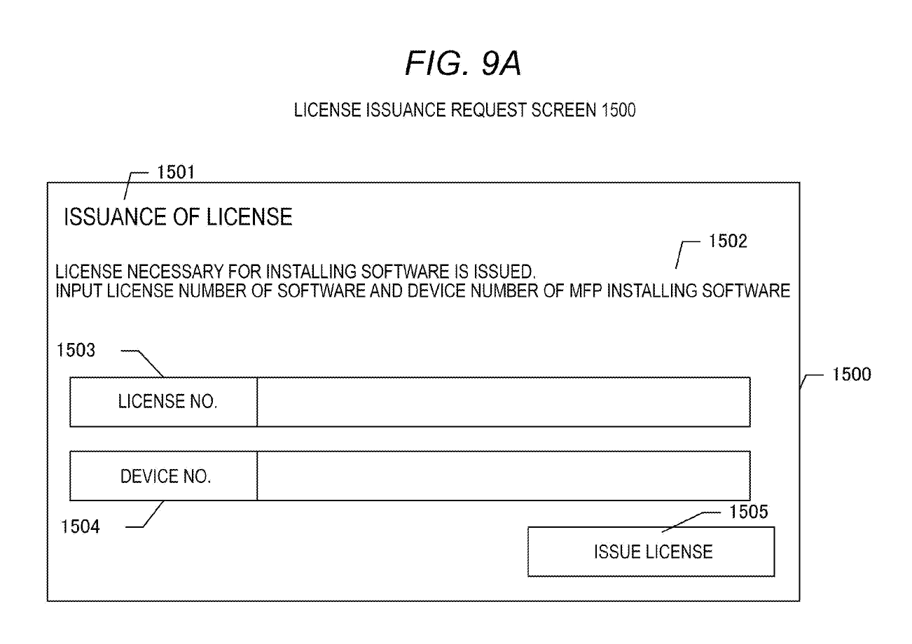

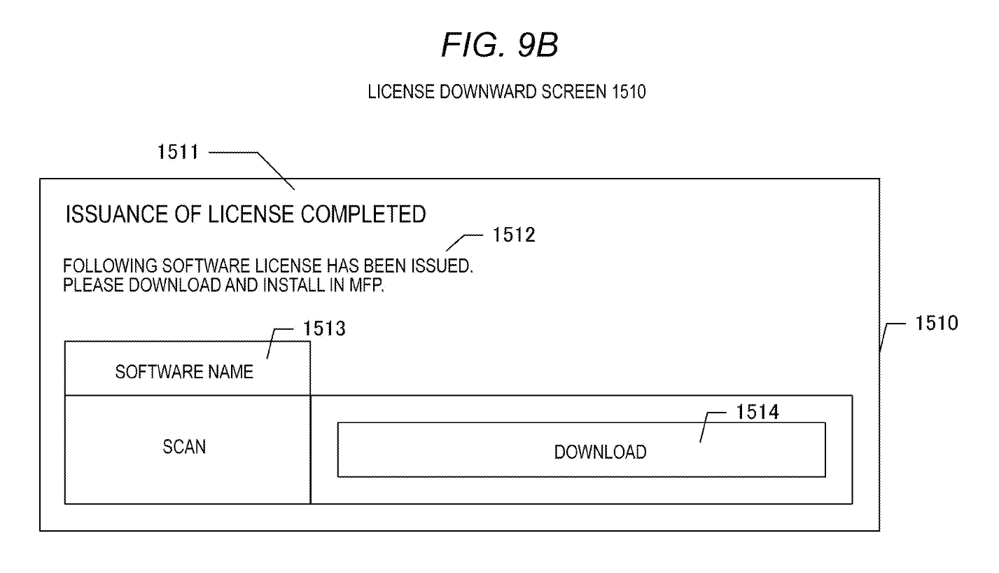

FIGS. 9A and 9B illustrates an example of a license issuance screen transmitted from the transmission unit 402 of the license management server 102 and displayed on the user interface 201 of the PC 103. The license issuance screen is displayed in a series of processes in the license management server 102, which will be described later, for issuing license for a complex merchandise including a MFP software merchandise for which device-to-device transfer is prohibited.

As shown in FIGS. 9A and 9B, the license issuance screen includes a license issuing request screen 1500 and a license download screen 1510.

The license issuing request screen 1500 is a screen for operation for transmitting a license issuing request to the license management server 102 in order to issue the license necessary for the user of the MFP 104 to install MFP software.

A title display label 1501 is a label indicating to the operator of the PC 103 that the operated screen is the screen for transmitting a license issuing request. A guidance message display label 1502 is a label for displaying, to the operator of the PC 103, a message prompting the input of information necessary for transmitting the license issuing request to the license management server 102. A license number input form 1503 is an input form for receiving, from the operator of the PC 103 via the user interface 201 of the PC 103, the license number corresponding to the MFP software. A device number input form 1504 is an input form for receiving, from the operator of the PC 103 via the user interface 201 of the PC 103, the device number of the MFP in which the MFP software is installed.

A license issuing request transmit button 1505 is a button for transmitting the license issuing request to the reception unit 401 of the license management server 102. When the button 1505 is depressed by the operator of the PC 103 via the user interface 201 of the PC 103, the license issuing request is transmitted to the license management server 102. The license issuing request includes the values input to the license number input form 1503 and the device number input form 1504.

The license download screen 1510 is a screen that the license management server 102 transmits to the user interface 201 as a response to the license issuing request in the event of successful issuance of license.

A title display label 1511 is a label indicating to the operator of the PC 103 that the operated screen is a screen for downloading the successfully issued license. A guidance message display label 1512 is a label for displaying to the operator of the PC 103 a message prompting license download. A software name display area 1513 is an area for displaying the merchandise name corresponding to the issued license in accordance with the license issuing request received by the license management server 102. In the software name display area 1513, in accordance with the license number included in the license issuing request, the value stored in the merchandise name column 622 or the complex merchandise name column 632 is displayed.

A download button 1514 is a button for acquiring the license issued by the license management server 102. When the button 1514 is depressed by the operator of the PC 103 via the user interface 201 of the PC 103, the license issued by the license management server 102 is downloaded from the license management server 102 to the PC 103. The downloaded license is stored in the secondary storage device 206 of the PC 103.

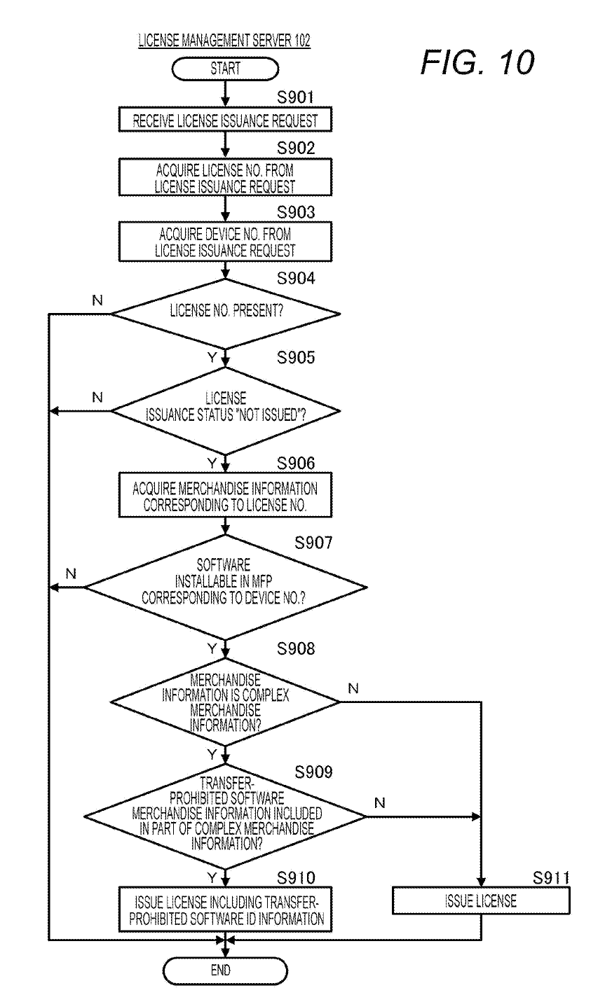

FIG. 10 is a flowchart illustrating a series of processes for issuing in the license management server 102 a license for a complex merchandise including a MFP software merchandise for which device-to-device transfer is prohibited. The processes of the flowchart are realized by the CPU 203 of the license management server 102 reading the program stored in the secondary storage device 206 and executing the program. The series of processes of the flowchart will be described as being performed between the license management server 102 and the PC 103 connected by the Internet 100. However, a similar operation may be performed between the license management server 102 and the MFP 104 connected by the Internet 100.

First, upon request from the PC 103 for the license issuance screen, in accordance with an instruction from the control unit 400 of the license management server 102, the transmission unit 402 transmits the license issuing request screen 1500 to the PC 103. Upon reception of the license issuing request screen 1500 from the transmission unit 402, the PC 103 displays the screen on the user interface 201, as shown in FIG. 9A. The operator of the PC 103 inputs, on the license issuing request screen 1500, the license number corresponding to the MFP software to be installed, and the device number of the MFP to be installed, and depresses the license issuing request transmit button 1505. In accordance with this operation, the PC 103 transmits a license issuing request including the input license number 1503 and device number 1504 to the license management server 102. Then, in S901, the reception unit 401 of the license management server 102 receives the license issuing request from the PC 103.

In S902, the license issuance determination unit 403 acquires the license number 1503 from the license issuing request received by the reception unit 401. In S903, the license issuance determination unit 403 acquires the device number 1504 from the license issuing request received by the reception unit 401.

In S904, the license issuance determination unit 403, with reference to the values in the license number column 641 of the respective data registered in the license number management table 640, determines whether there is data having a value corresponding to the value of the license number 1503. If it is determined that there is no data having the value corresponding to the value of the license number 1503 (“No” in S904), the license issuance determination unit 403 determines that the license cannot be issued. Then, the transmission unit 402 of the license management server 102 transmits to the user interface 201 of the PC 103 a screen (not shown) displaying the fact of failure in the issuance of license, whereby the series of license issuance processes is completed.

On the other hand, if it is determined in S904 that there is data having the value corresponding to the value of the license number 1503 (“Yes” in S904), the license issuance determination unit 403 proceeds to S905.

In S905, the license issuance determination unit 403 confirms the value of the license issuing status column 644 of the data found to be corresponding in S904. If it is determined that the value of the license issuing status column 644 is “issued” (“No” in S905), the license issuance determination unit 403 determines that license cannot be issued. Then, the transmission unit 402 of the license management server 102 transmits to the user interface 201 of the PC 103 a screen (not shown) displaying the fact of failure in issuance of license, whereby the series of license issuance processes is completed.

On the other hand, if it is determined that the value of the license issuing status column 644 is “not issued” (“Yes” in S905), the license issuance determination unit 403 proceeds to S906. In S906, the license issuance determination unit 403 acquires the value of the merchandise ID column 642 of the data found to be corresponding in S904. The license issuance determination unit 403, with reference to the value of the merchandise ID column 621 of the respective data registered in the merchandise information management table 620, confirms if there is data having a value corresponding to the value of the merchandise ID column 642. If there is corresponding data, the license issuance determination unit 403 acquires the value (relevant merchandise information) of the device merchandise ID column 624 included in the data. Further, the license issuance determination unit 403, with reference to the value of the device merchandise ID column 601 of the respective data registered in the device merchandise information management table 600, acquires data (relevant device merchandise information) corresponding to the acquired value of the device merchandise ID column 624, and proceeds to S907.

In S907, the license issuance determination unit 403 confirms if installation is enabled based on whether the value of the device number 1504 acquired in S903 is included within the device number range determined by the type column 603 and the range number column 604 of the relevant device merchandise information acquired in S906. For example, if the value of the device number 1504 included in the license issuing request is “AAA12345”, the type of the relevant merchandise information is “AAA”, and the range number is “00000 to 99999”, the device number value is included, so that it is determined that installation is possible. On the other hand, if the type of the relevant merchandise information is “BBB” and the range number is “00000 to 123456”, the device number value is not included, so that it is determined that installation is not possible. The license issuance determination unit 403 also determines that installation is not possible when the merchandise information or device merchandise information corresponding to the license number could not be acquired in S906.

When it is determined in S907 that installation is not possible (“No” in S907), the transmission unit 402 of the license management server 102 transmits to the user interface 201 of the PC 103 a screen (not shown) displaying the fact of failure in issuance of license, whereby the series of license issuance processes is completed.

On the other hand, if it is determined in S907 that installation is possible (“Yes” in S907), the license issuance determination unit 403 proceeds to S908.

In S908, the license issuance determination unit 403 confirms if the merchandise information acquired in S906 is an element of a complex merchandise. The license issuance determination unit 403 refers to the value of the complex merchandise ID column 643 of the data acquired in S904. If a value is stored in the complex merchandise ID column 643, the license issuance determination unit 403 determines that the merchandise information corresponding to the license number 1503 is an element of a complex merchandise (“Yes” in S908), and proceeds to S909. On the other hand, if no value is stored in the complex merchandise ID column 643, the license issuance determination unit 403 determines that the merchandise information corresponding to the license number 1503 is not an element of a complex merchandise (“No” in S908), and proceeds to S911.

In S909, the license issuance determination unit 403 confirms if transfer-prohibited software merchandise information is registered together with the merchandise information corresponding to the license number 1503 as the same complex merchandise. The license issuance determination unit 403, with reference to the value of the complex merchandise ID column 631 of the respective data of the complex merchandise information management table 630, acquires the value of the merchandise ID column 633 included in the data corresponding to the value of the complex merchandise ID column 643 acquired in S908. Then, the license issuance determination unit 403, with reference to the value of the merchandise ID column 621 of various data of the merchandise information management table 620, acquires all of merchandise information that agree with the merchandise ID included in the merchandise ID column 633. Further, the license issuance determination unit 403, with reference to the value of the software ID column 611 of the respective data of the software information management table 610, acquires all of software information that agree with the value of the software ID column 623 included in the acquired merchandise information. Finally, the license issuance determination unit 403 refers to the value of the transferability column 613 of the acquired software information. If in the acquired software information there is even one item with the value of the transferability column 613 of “No”, the license issuance determination unit 403 determines that a transfer-prohibited software merchandise is included as an element of the complex merchandise (“Yes” in S909), and proceeds to S910. On the other hand, if there is not even a single item with the value of the transferability column 613 of “No”, the license issuance determination unit 403 determines that a transfer-prohibited software merchandise is not included as an element of a complex merchandise (“No” in S909), and proceeds to S911.

In S910, the license issuance unit 404 issues the license 810. First, the license information management unit 408 stores license information corresponding to the license number 1503 in the license management table 650 respectively. Specifically, the license information management unit 408 generates a value that can uniquely identify the license information registered in the license ID column 651 and stores the value in the license management table 650. Normally, sequential values are registered in ascending order in order of registration of the license information. Further, the license information management unit 408 stores the value of the license number 1503 in the license number column 652. The license information management unit 408 also stores the value of the device number 1504 in the device number column 653. In the software ID column 654, the license information management unit 408 stores the value of the software ID column 623 of the merchandise information acquired in S906. Further, the license information management unit 408 stores the value “TRUE” in the transfer-prohibited software identification information column 655. Based on the license information stored in the license management table 650, the license issuance unit 404 issues the license 810. Thus, the license 810 corresponding to the license issuing request received in S901 is stored in the secondary storage device 206 of the license management server 102 as a license file. The license information management unit 408 then refers to the license number management table 640, and stores the value “issued” in the license issuing status column 644 of the license number information of which the value of the license number column 641 agrees with the license number 1503. Finally, the transmission unit 402 of the license management server 102 transmits the license download screen 1510 to the PC 103, and ends the series of license issuance processes. When the download button 1514 of the license download screen 1510 is depressed, the created license 810 is downloaded in the PC 103.

In S911, the license issuance unit 404 issues the license 800. First, the license information management unit 408 stores in the license management table 650 license information corresponding to the license number 1503 respectively. Description of information stored in the license number column 652, the device number column 653, and the software ID column 654 will be omitted as they are similar to those described with reference to S910. The license information management unit 408 does not store a value in the transfer-prohibited software identification information column 655. Based on the license information stored in the license management table 650, the license issuance unit 404 issues the license 800. Thus, the license 800 corresponding to the license issuing request received in S901 is stored in the secondary storage device 206 of the license management server 102 as a license file. The license information management unit 408 also refers to the license number management table 640 and stores the value “issued” in the license issuing status column 644 of the license number information of which the value of the license number column 641 agrees with the license number 1503. Finally, the transmission unit 402 of the license management server 102 transmits the license download screen 1510 to the PC 103 and ends the series of license issuance processes. When the download button 1514 of the license download screen 1510 is depressed, the created license 800 is downloaded in the PC 103.

The license management server 102, when the software as the object of issuance of license is software for which movement of license to another information processing device is prohibited, or which is in dependence relationship with the software for which movement of license to another information processing device is prohibited (included in the same complex merchandise), issues a license to which transfer-prohibited software identification information indicating that movement of license to another information processing device is prohibited (transfer prohibition information) is attached.

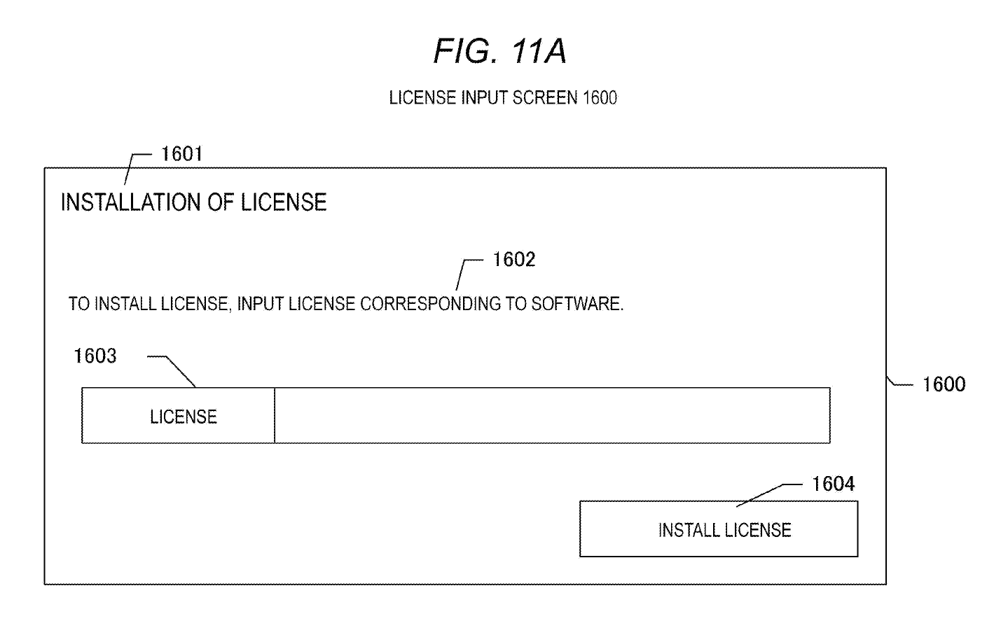

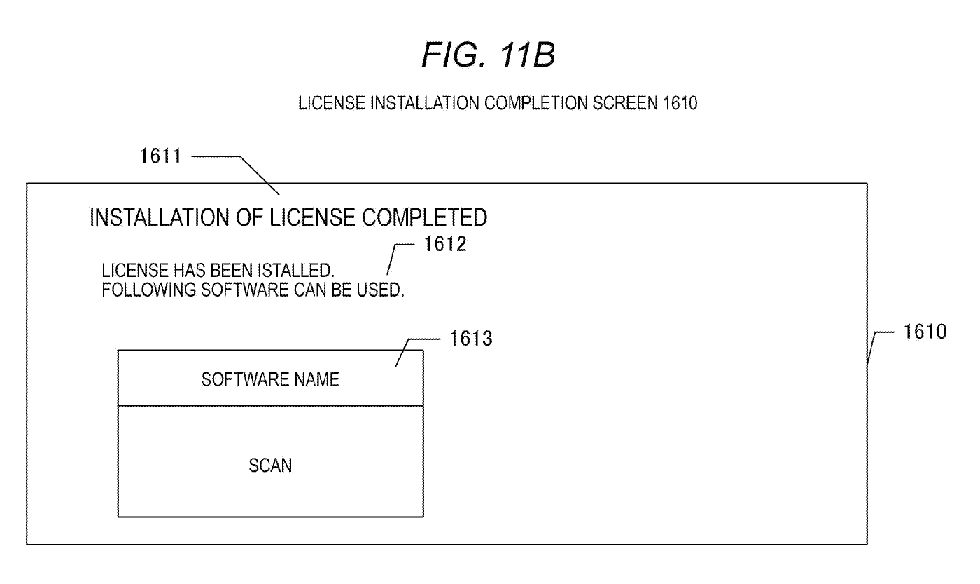

FIGS. 11A and 11B illustrate examples of the license installation screen displayed on the operating unit 307 of the MFP 104 in the series of operations for installing MFP software license in the MFP 104.

As shown in FIGS. 11A and 11B, the license installation screen includes a license input screen 1600 and a license installation completion screen 1610. The license input screen 1600 is a screen for the user of the MFP 104 to designate the license 800 or 810 corresponding to the installed software.

The title display label 1601 is a label for displaying to the operator of the MFP 104 that the operated screen is a license input screen. The guidance message display label 1602 is a label for displaying to the operator of the MFP 104 a message prompting the input of license.

The license input form 1603 is a form for receiving from the user of the MFP 104 the input of the license 800 or 810 via the operating unit 307 of the MFP 104. In the license input form 1603, a path of the license file corresponding to the license 800 or 810 is designated.

The install start button 1604 is a button for starting license installation. When the button 1604 is depressed by the user of the MFP via the operating unit 307 of the MFP 104, installation of the license input to the license input form 1603 is started. Upon successful installation, the MFP software corresponding to the license becomes utilizable in the MFP 104.

The license installation completion screen 1610 is a screen displayed on the operating unit 307 upon successful installation of the license by the MFP 104. A title display label 1611 is a label for displaying to the operator of the MFP 104 that the operated screen is a license installation completion screen. A guidance message display label 1612 is a label displaying to the operator of the MFP 104 that license installation has been completed. An installed software display area 1613 is an area displaying the names of software that has become utilizable by the completion of license installation. The license installation screen shown in FIGS. 11A and 11B may be displayed on the user interface 201 of the PC 103. In this case, the MFP 104 in which the license is to be installed is designated from the PC 103. For example, the MFP 104 in which the license is installed is remotely logged in from the PC 103.

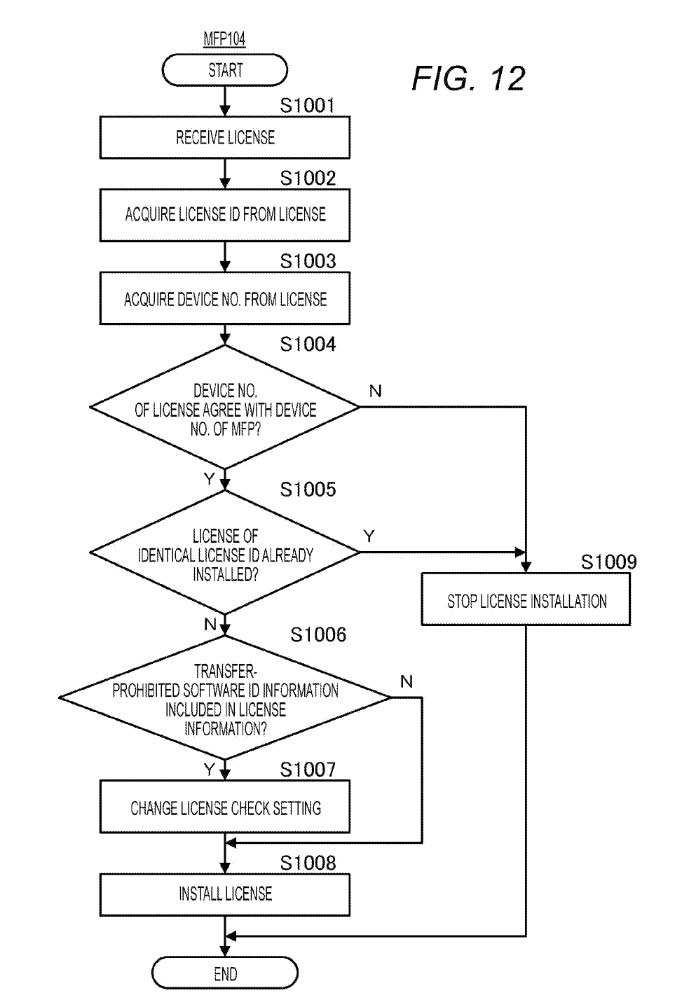

FIG. 12 is a flowchart of a series of processes for installing MFP software license in the MFP 104. The processes of the flowchart are executed by the CPU 302 of the MFP 104 executing a program stored in the ROM 303 and the like, with the process in each step being executed by various constituent elements in accordance with an instruction from the control unit 500. The present exemplary embodiment is based on the following. MFP software is placed in the secondary storage device 305 of the MFP 104 prior to license installation. The license is independently installed and then the MFP software is installed using the license. Obviously, the license and the MFP software may be installed in the MFP 104 together. While the license input screen 1600 is assumed to be displayed on the operating unit 307 of the MFP 104, the screen may be similarly displayed on the user interface 201 of the PC 103.

The control unit 500 of the MFP 104 displays the license input screen 1600 on the operating unit 307 in accordance with an operation via the operating unit 307. As the install start button 1604 is depressed, the reception unit 501 in S1001 receives the license 800 or 810 designated in the license input form 1603.

In S1002, the license authentication unit 506 acquires the value of the license ID column 801 or 811 from the license 800 or 810 received by the reception unit 501 in S1001. In S1003, the license authentication unit 506 acquires the value of the device number column 803 or 813 from the license 800 or 810 received by the reception unit 501 in S1001.

In S1004, the license authentication unit 506 acquires the value of the device number column 702 of the MFP information management table 700. The license authentication unit 506 then compares the value of the device number column 803 or 813 acquired in S1003 with the value of the device number column 702 to determine whether they agree with each other. If it is determined that the value of the device number column 803 or 813 and the value of the device number column 702 do not agree (“No” in S1004), the license authentication unit 506 interrupts license installation in S1009.

On the other hand, if it is determined that the value of the device number column 803 or 813 and the value of the device number column 702 agree (“Yes” in S1004), the license authentication unit 506 determines that the received license is a license issued for the MFP 104, and proceeds to S1005.

In S1005, the license authentication unit 506 refers to the value of the license ID column 721 of the respective data registered in the license information management table 720, and compares the value with the value of the license ID column 801 or 811 acquired in S1002. If the value agreeing with of the value of the license ID column 801 or 811 is present in the license ID column 721 of the license information management table 720, the license authentication unit 506 determines that the license received in S1001 is already installed. In this case, the license authentication unit 506 makes a “Yes” determination in S1005, and interrupts license installation in S1009.

On the other hand, if the value agreeing with the value of the license ID column 801 or 811 is not present in the license ID column 721 of the license information management table 720, the license authentication unit 506 determines that the license received in S1001 is not yet installed. In this case, the license authentication unit 506 makes a “No” determination in S1005 and proceeds to S1006.

In S1006, the license authentication unit 506 confirms if the license received in S1001 is license 810 for a complex merchandise including a transfer-prohibited software merchandise. Specifically, the license authentication unit 506 confirms if the license retains the value of the transfer-prohibited software identification information column 814. If the license retains the value of the transfer-prohibited software identification information column 814, and the value is “TRUE”, the license authentication unit 506 determines that a transfer-prohibited software merchandise is included (“Yes” in S1006), and proceeds to S1007. In S1007, the license authentication unit 506 stores the value “TRUE” in the transfer-prohibited software identification information column 723 of the record of the license information management table 720 in which the data of the license is registered in S1008 as will be described below, and then proceeds to S1008.

On the other hand, if it is determined in S1006 that the license does not retain the value of the transfer-prohibited software identification information column 814, the license authentication unit 506 determines that a transfer-prohibited software merchandise is not included (“No” in S1006), and directly proceeds to S1008.

In S1008, the license authentication unit 506 registers the respective data of the license 800 or 810 in the license information management table 720. Specifically, the license authentication unit 506 stores the value of the license ID acquired in S1002 in the license ID column 721. The license authentication unit 506 also stores, in the software ID column 722, the value of the software ID column 802 or 812 of the license received in S1001. Further, the license authentication unit 506 stores the value of the date/time of the series of license installation processes shown in FIG. 12 in the installation date/time column 724. The license authentication unit 506 further stores the license and various data about the performed processes in the license installation history management table 730. Specifically, the license authentication unit 506 stores the value of the license ID column 721 in the license ID column 731. The license authentication unit 506 stores the value of the software ID column 722 in the software ID column 732. Further, the license authentication unit 506 stores the value of the installation date/time column 724 in the installation date/time column 733. When the series of installation processes shown in FIG. 12 is performed, the license authentication unit 506 does not store any value in the uninstallation date/time column 734. Finally, the license authentication unit 506 displays the license installation completion screen 1610 on the operating unit 307.

By performing the above-described series of license installation processes and using the installed license, the MFP software is installed and becomes usable in the MFP 104.

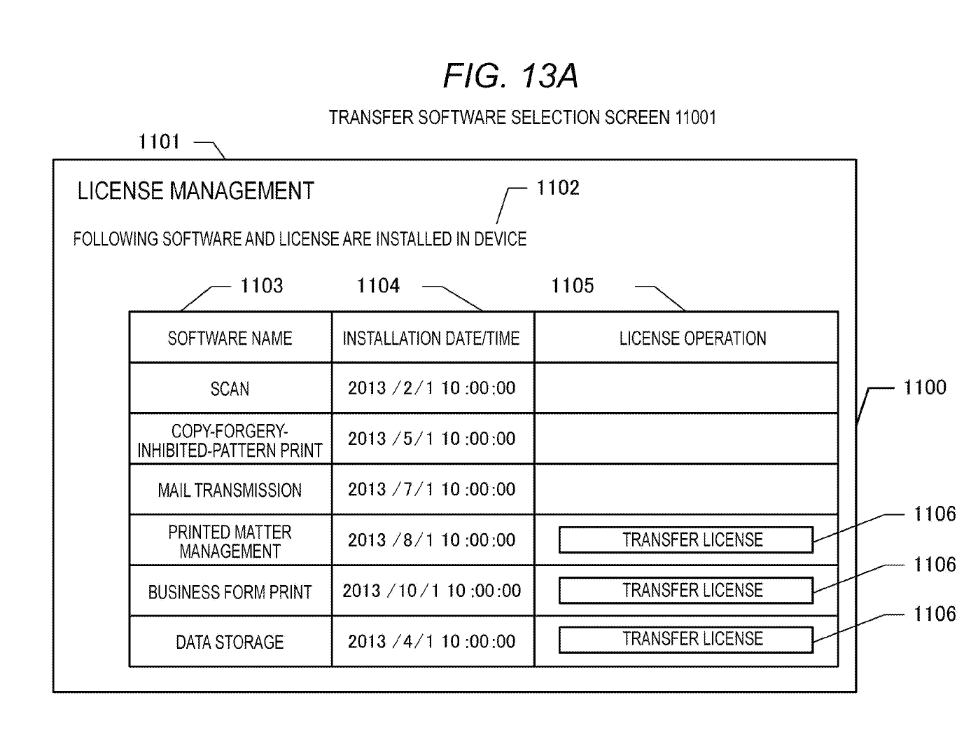

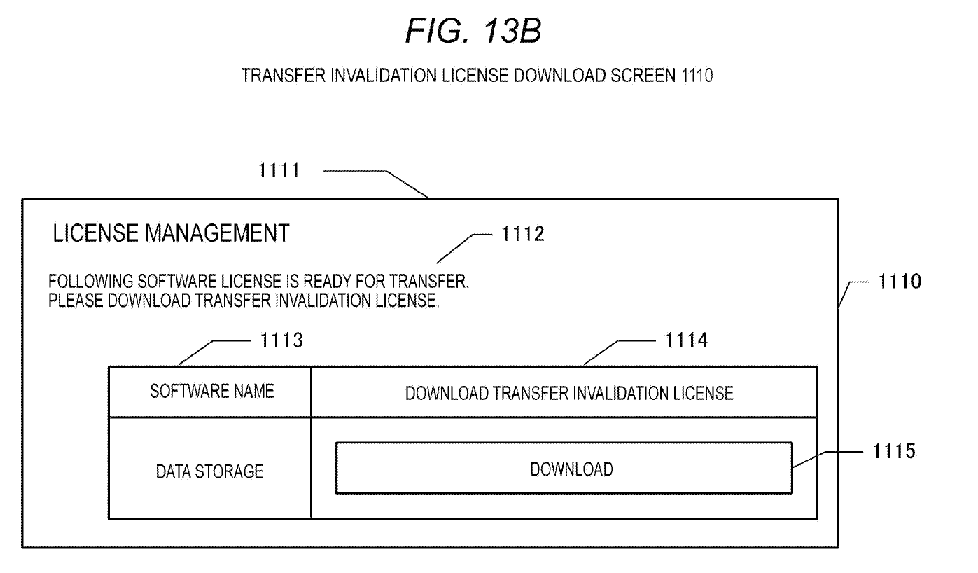

FIGS. 13A and 13B illustrate examples of a license management screen displayed on the operating unit 307 of the MFP 104 in a series of license transfer processes required for re-utilizing the MFP software installed in the MFP 104 in a different MFP.

The license management screen is used for issuing a invalidation license for transfer necessary for uninstalling MFP software license from the MFP 104 and for enabling the license management server 102 to issue a transfer license utilizable in a different MFP. The invalidation license for transfer includes information (invalidation information) issued to invalidate (by deletion, for example) the license on the MFP and prove that the license has been invalidated so that the license used for utilization of software can be moved to another MFP.

The license management screen includes a transfer software selection screen 1100 and an invalidation license for transfer download screen 1110.

The transfer software selection screen 1100 is a screen the user of the MFP 104 uses to select a MFP software license as the object of transfer to a different MFP. A title display label 1101 is a label for displaying to the operator of the MFP 104 that the operated screen is a license management screen. A guidance message display label 1102 is a label displaying to the operator of the MFP 104 that the license for software displayed on the screen is already installed. In a software name display area 1103, an installation date/time display area 1104, and a licensing operation area 1105, the respective data registered in the MFP software information management table 710 and the license information management table 720 of the MFP 104 are displayed.

The software name display area 1103 is an area for displaying the name of the MFP software for which license is installed in the MFP 104. Specifically, this is an area for displaying the value of the software name column 712 of the respective data registered in the MFP software information management table 710. The installation date/time display area 1104 is an area for displaying the installation date/time of the MFP software for which license is installed in the MFP 104. Specifically, this is an area for displaying the value of the installation date/time column 724 of the license information of which the value of the software ID column 711 of the respective data registered in the MFP software information management table 710 and the value of the license ID column 721 agree with each other.

The licensing operation area 1105 is an area for displaying a button for an executable operation with respect to the license for the MFP software installed in the MFP 104. When there is no executable operation with respect to the license, the licensing operation area 1105 does not display anything. Specifically, whether a button is displayed is determined by the value of the transfer-prohibited software identification information column 723 of the license information of which the value of the software ID column 711 of the respective data registered in the MFP software information management table 710 and the value of the license ID column 721 agree with each other. When no value is stored in the transfer-prohibited software identification information column 723, a license transfer button 1106 is displayed. When the value “TRUE” is stored in the transfer-prohibited software identification information column 723, the license transfer button 1106 is hidden.

The license transfer button 1106 is a button displayed when the MFP software is in transfer license issuable state. When the button 1106 is depressed by the operator of the MFP 104 via the operating unit 307 of the MFP 104, an invalidation license for transfer is issued. Specifically, when the license transfer button 1106 is depressed, the control unit 500 issues an invalidation request, which is received by the reception unit 501. Upon reception of the license invalidation request by the reception unit 501, first the license authentication unit 506 deletes, from among the various data in the license information management table 720, license information corresponding to the depressed license transfer button 1106. Further, the license authentication unit 506 issues an invalidation license for transfer. By this series of processes, the relevant MFP software becomes inexecutable from the MFP 104, and the license information is also deleted. The invalidation license for transfer includes data proving that the license information for the MFP software installed in the MFP 104 has been deleted, and that the MFP software is now in unusable state. The invalidation license for transfer includes a license ID 801, a software ID 802, and a device number 803 stored in the invalidated license. The invalidation license for transfer is transmitted to the license management server 102 in a license transfer process which will be described later. Based on the invalidation license for transfer, the license management server 102 corrects the data generated and registered when license was issued for the MFP in the past. The license management server 102 and the MFP 104 maintain data consistency so that transfer license can be newly issuable to a transfer destination MFP.

The invalidation license for transfer download screen 1110 is a screen for performing an operation for downloading the invalidation license for transfer for the MFP software of which issuance has been completed to the PC 103 and the like. The screen 1110 is displayed when the license transfer button 1106 is depressed.

A title display label 1111 is a label displaying to the operator of the MFP 104 that the operated screen is a screen for downloading invalidation license for transfer. A guidance message display label 1112 is a label prompting the operator of the MFP 104 to download the invalidation license for transfer. A software name display area 1113 is an area for displaying the name of the MFP software for which uninstallation and issuance of invalidation license for transfer have been completed. An invalidation license for transfer download area 1114 is an area for displaying the invalidation license for transfer download button 1115 for the MFP software of which issuance has been completed.

The invalidation license for transfer download button 1115 is a button displayed when the issuance of invalidation license for transfer for the MFP software is completed. When the button 1115 is depressed by the operator of the MFP 104 via the operating unit 307 of the MFP 104, the invalidation license for transfer is stored at an operator-designated storage location in the form of a file. For example, the invalidation license for transfer is stored in the secondary storage device 206 of the PC 103 (such as in the secondary storage device 305 of the MFP 104).

The license management screen shown in FIGS. 13A and 13B may be displayed on the user interface 201 of the PC 103. In this case, the PC 103 may be logged-in to the MFP 104 remotely.

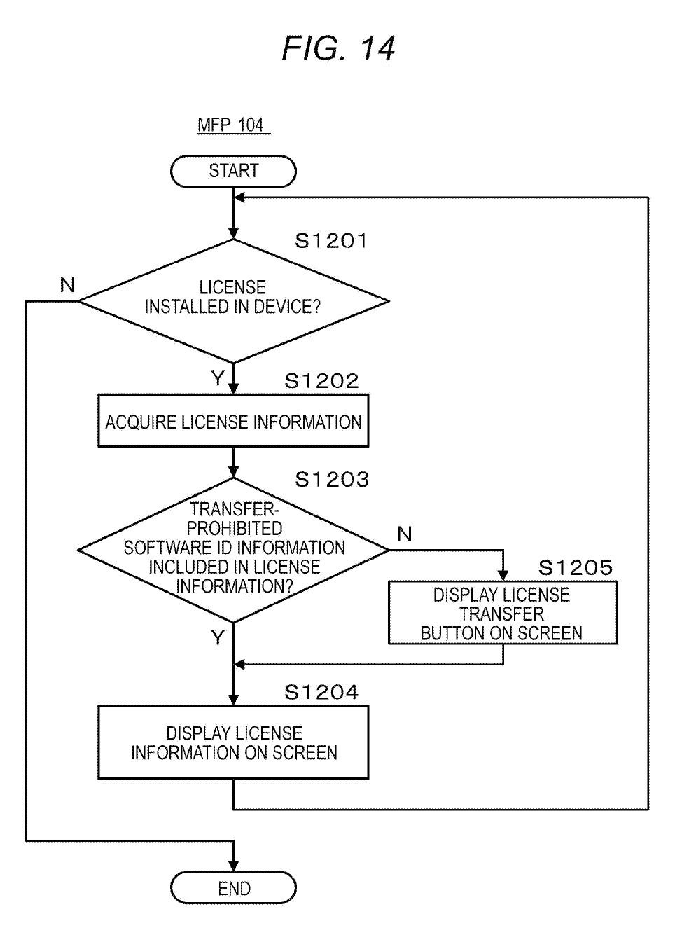

FIG. 14 is a flowchart of a series of processes for displaying the license management screen on the operating unit 307 of the MFP 104. The processes of the flowchart of FIG. 14 are executed by the CPU 302 of the MFP 104 executing a program stored in the ROM 303 and the like, with the steps being executed by various constituent elements in accordance with an instruction from the control unit 500.

The control unit 500 of the MFP 104 acquires information about each element displayed on the transfer software selection screen 1100 displayed on the operating unit 307 in accordance with an operation via the operating unit 307 by executing the processes of the flowchart of FIG. 14. Thus, the elements displayed on the license management screen vary depending on the content of the license installed in the MFP 104.

First, in S1201, the license information management unit 505 of the MFP 104, with reference to the license information management table 720, confirms if MFP software license is installed in the MFP 104. Specifically, the license information is referenced one by one in ascending order in the license ID column 721 of the license information management table 720. If it is confirmed as a result of the referring that license information is registered, the license information management unit 505 determines “Yes” in S1201, and executes the processes of S1202 to S1205.

When the series of processes of S1201 to S1205 has been executed and all of the license information have been referenced, or no data is registered in the license information management table 720, the license information management unit 505 determines “No” in S1201 and ends the processes of the present flowchart.

In S1202, the license information management unit 505 acquires the license information referenced in S1201 among the license information registered in the license information management table 720. In the following, the acquired license information will be referred to as “current license information”.

In S1203, the license information management unit 505 confirms the value of the transfer-prohibited software identification information column 723 of the current license information. If the value of the transfer-prohibited software identification information column 723 is “TRUE”, the license information management unit 505 determines that transfer-prohibited software identification information is included in the license information (“Yes” in S1203). In this case, the license information management unit 505 proceeds to S1204 without displaying the license transfer button 1106 in the licensing operation area 1105 of the transfer software selection screen 1100.

On the other hand, if it is determined in S1203 that no value is stored in the transfer-prohibited software identification information column 723, the license information management unit 505 determines that transfer-prohibited software identification information is not included in the license information (“No” in S1203). In this case, the license information management unit 505 proceeds to S1205. In S1205, the license information management unit 505 displays the license transfer button 1106 in the licensing operation area 1105 of the transfer software selection screen 1100 corresponding to the license information acquired in S1202, and proceeds to S1204.

In S1204, the license information management unit 505 displays the value of each of the columns corresponding to the current license information on the transfer software selection screen 1100. Specifically, the license information management unit 505, with reference to the MFP software information management table 710, acquires the MFP software information of which the value of the software ID column 722 of the current license information and the value of the software ID column 711 agree with each other. The license information management unit 505 then displays the value of the software name column 712 included in the acquired MFP software information in the software name display area 1103. Further, the license information management unit 505 displays the value of the installation date/time column 724 of the current license information in the installation date/time display area 1104. When the process of S1204 is completed, the license information management unit 505 causes the process to transition to S1201 so as to move the process to the next license information.

By the above-described series of operation, the transfer software selection screen 1100 is created and displayed on the operating unit 307 of the MFP 104. At this time, the screen is controlled so that the operation for issuing an invalidation license for transfer file cannot be performed with respect to a software merchandise including a transfer-prohibited software merchandise as an element of the same complex merchandise, as in S1203.

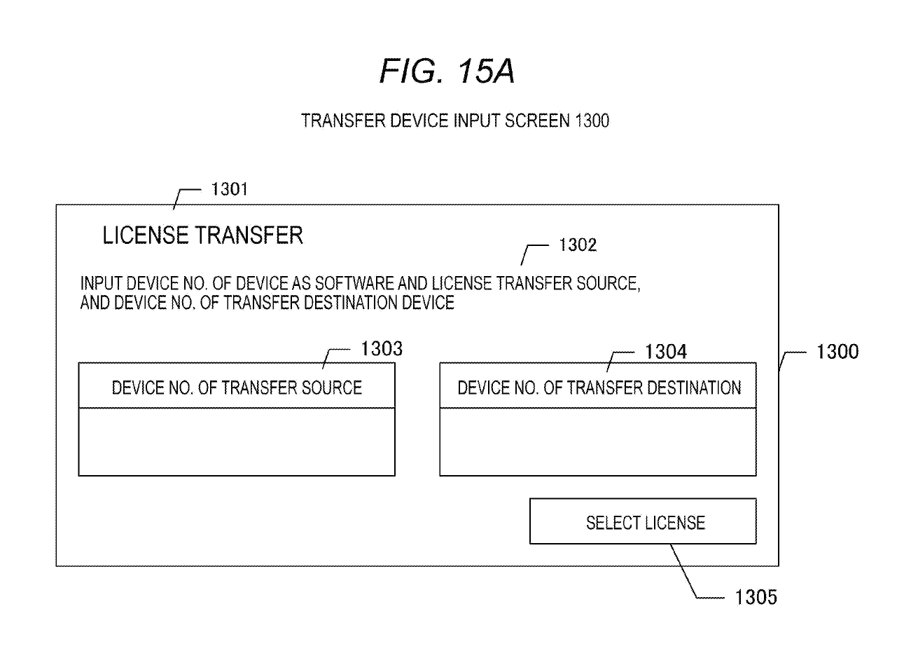

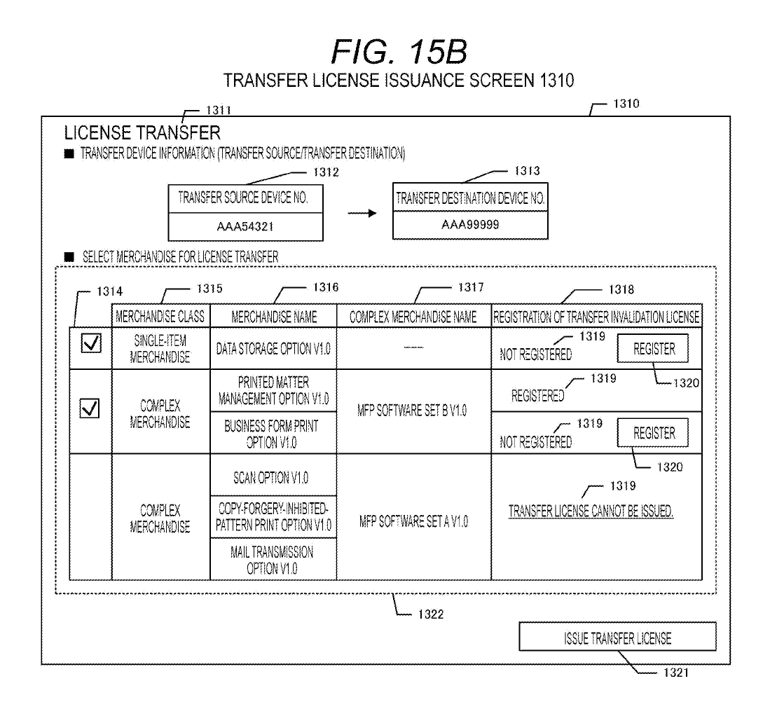

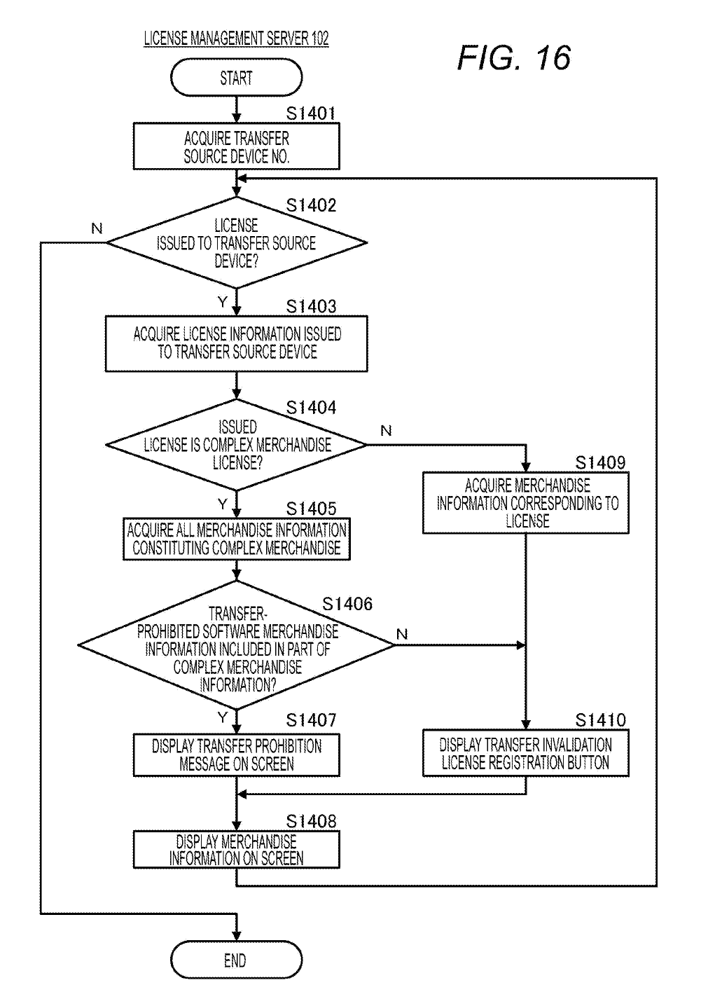

FIGS. 15A and 15B illustrates an example of the license transfer screen displayed on the user interface 201 of the PC 103 in a series of processes for issuing a transfer license.

By operating the license transfer screen shown in FIGS. 15A and 15B, the device number of the MFP as a license transfer destination and the invalidation license for transfer and the like acquired from the transfer source MFP via the license management screen shown in FIGS. 13A and 13B are transmitted to the license management server 102. The screen may be operated to issue a transfer license enabling the movement of license to the transfer destination MFP, or to prevent re-issuance of license to the transfer source MFP. Thus, unauthorized issuance and utilization of a greater number of licenses than the number of MFPs assumed can be prevented. A series of operations concerning the issuance of transfer license via the present screen will be described later with reference to FIG. 16.

As shown in FIGS. 15A and 15B, the license transfer screen includes a transfer device input screen 1300 and a transfer license issuance screen 1310.

A transfer device input screen 1300 is a screen for the user of an MFP to input the device number of the MFP as a transfer source in which MFP software license is currently installed, and the device number of the MFP as a transfer destination in which the license is to be utilized.

A title display label 1301 is a label displaying to the operator of the PC 103 that the operated screen is a transfer license issuance screen. A guidance message display label 1302 is a label displaying to the operator of the PC 103 a message prompting the input of the device number of each of the transfer source and transfer destination MFPs. A transfer source device number input form 1303 is a form for the input of the device number of the MFP in which MFP software as the object of transfer and its license are currently installed. A transfer destination device number input form 1304 is a form for the input of the device number of the MFP as the license transfer destination.

A license selection button 1305 is a button for transmitting the values input in the transfer source device number input form 1303 and the transfer destination device number input form 1304 to the license management server 102. When the button 1305 is depressed by the operator of the PC 103 via the user interface 201 of the PC 103, the values input in the transfer source device number input form 1303 and the transfer destination device number input form 1304 are transmitted to the license management server 102. In response, the license management server 102 generates the transfer license issuance screen 1310 and provides the screen to the PC 103. Namely, when the license selection button 1305 is depressed, the transfer license issuance screen 1310 is displayed on the user interface 201 of the PC 103.

The transfer license issuance screen 1310 is a screen for issuing transfer license to the MFP of which the device number has been input in the transfer destination device number input form 1304. The operator of the PC 103 operates the transfer license issuance screen 1310 to select MFP software license for transfer from among the MFP software installed in the transfer source MFP.

A title display label 1311 is a label displaying to the operator of the PC 103 that the operated screen is a transfer license issuance screen. A transfer source device number display area 1312 is an area for displaying the device number of the MFP as the license transfer source, in which the value input in the transfer source device number input form 1303 is displayed. A transfer destination device number display area 1313 is an area for displaying the device number of the MFP as the license transfer destination, in which the value input in the transfer destination device number input form 1304 is displayed.

An installed merchandise display area 1322 is an area for displaying the merchandise information of the license issued by the license management server 102 to the MFP of the device number displayed in the transfer source device number display area 1312. From among the respective data registered in the license management table 650, as many items of the following information are displayed as the number of the licenses issued to the MFP of the device number displayed in the transfer source device number display area 1312. Namely, a transfer object merchandise selection check box 1314, a merchandise class display area 1315, a merchandise name display area 1316, a complex merchandise name display area 1317, and a invalidation license for transfer registration area 1318 are displayed.

The transfer object merchandise selection check box 1314 is a check box for designating the merchandise for which transfer license is to be issued from among a list of the merchandise information displayed in the installed merchandise display area 1322. When the check box 1314 is selected by the operator of the PC 103, the invalidation license for transfer registration button 1320 is placed in a depressible state. Whether the transfer object merchandise selection check box 1314 is displayed is determined depending on the class of the merchandise information corresponding to the license issued by the license management server 102. Specifically, when the class of merchandise information is single-item merchandise or complex merchandise not including transfer-prohibited software merchandise, the transfer object merchandise selection check box 1314 is displayed. When the class of merchandise information is complex merchandise including transfer-prohibited software merchandise, the transfer object merchandise selection check box 1314 is hidden. A detailed process will be described later with reference to a flowchart of FIG. 16.

The merchandise class display area 1315 is an area for displaying information as to whether the MFP software installed in the transfer source MFP is a single-item merchandise or a complex merchandise. The merchandise name display area 1316 is an area for displaying merchandise information of the MFP software merchandise installed in the transfer source MFP. The complex merchandise name display area 1317 is an area for displaying, when the MFP software merchandise installed in the transfer source MFP is a complex merchandise, the name of the complex merchandise name.

The invalidation license for transfer registration area 1318 is an area for displaying a message and a button necessary for invalidation license for transfer registration. In the invalidation license for transfer registration area 1318, a registration status display area 1319 and an invalidation license for transfer registration button 1320 are displayed.

The registration status display area 1319 is an area for displaying a registration status of the invalidation license for transfer corresponding to the MFP software merchandise selected in the transfer object merchandise selection check box 1314. When the invalidation license for transfer is not registered, “not registered” is displayed. When the invalidation license for transfer is registered, “registered” is displayed, and the invalidation license for transfer registration button 1320 is hidden. When the value of the merchandise class display area 1315 is “complex merchandise” and a transfer-prohibited software merchandise is included in the merchandise name display area 1316, the user of the PC 103 is notified that the issuance itself of transfer license is prohibited for the complex merchandise via a message displayed in the registration status display area 1319.

The invalidation license for transfer registration button 1320 is a button for receiving from the operator of the PC 103 the invalidation license for transfer corresponding to the MFP software merchandise selected in the transfer object merchandise selection check box 1314. Specifically, the operator of the PC 103 depresses the invalidation license for transfer registration button 1320, and sets, using a file path and the like on a screen not shown, the invalidation license for transfer downloaded as a file in the secondary storage device 206 and the like of the PC 103. When the invalidation license for transfer is set using the registration button 1320, the registration status display area 1319 is modified to “registered”, and the invalidation license for transfer registration button 1320 is hidden. A detailed process will be described with reference to the flowchart of FIG. 16.

A transfer license issuing button 1321 is a button for issuing a transfer license. When the button 1321 is depressed by the operator of the PC 103, the value of the transfer destination device number display area 1313 and a transfer license issuance request including the invalidation license for transfer file registered by the registration button 1320 are transmitted to the license management server 102. In response, the license management server 102 issues a transfer license.

When the user of the PC 103 selects the transfer object merchandise selection check box 1314 of which the value of the merchandise class display area 1315 corresponds to the merchandise information “single-item merchandise”, the transfer license issuing button 1321 is placed in depressible state at the point in time of registration of the invalidation license for transfer corresponding to the “single-item merchandise”.

On the other hand, when the user of the PC 103 selects the transfer object merchandise selection check box 1314 of which the value of the merchandise class display area 1315 corresponds to the merchandise information “complex merchandise”, the transfer license issuing button 1321 is placed in depressible state at the point in time of registration of the invalidation license for transfer corresponding to all of the merchandise information belonging to the “complex merchandise”.

By performing such control on the transfer license issuance screen 1310, it becomes possible to prevent the license for a complex merchandise from being partially transferred to a different MFP and to ensure that all of the license for a complex merchandise will be transferred to a different MFP at once.

FIG. 16 is a flowchart illustrating a series of processes for displaying the license transfer screen on the user interface 201 of the PC 103. The processes of the flowchart of FIG. 16 are realized by the CPU 203 of the license management server 102 reading a program stored in the secondary storage device 206 and executing the program, with the process of each step being executed by various constituent elements in accordance with an instruction from the control unit 400.

In response to the license transfer screen display request from the PC 103, the control unit 400 of the license management server 102 acquires information about each of the elements displayed on the license transfer screen transmitted to the PC 103 by executing the operation of the flowchart of FIG. 16. Thus, the elements displayed on the license transfer screen vary depending on the content of the license issued to the MFP 104.

First, upon reception of the license transfer screen display request from the PC 103, the transmission unit 402 transmits the transfer device input screen 1300 to the PC 103 in accordance with an instruction from the control unit 400 of the license management server 102. Upon reception of the transfer device input screen 1300 from the transmission unit 402, the PC 103 displays the transfer device input screen 1300 on the user interface 201. The operator of the PC 103 then inputs the device numbers in the transfer source device number input form 1303 and the transfer destination device number input form 1304 of the transfer device input screen 1300, and then depresses the license selection button 1305. In accordance with this operation, the PC 103 transmits the values in the transfer source device number input form 1303 and the transfer destination device number input form 1304 to the license management server 102. The values of the transfer source device number input form 1303 and the transfer destination device number input form 1304 transmitted from PC 103 are received by the reception unit 401 of the license management server 102. In response, in S1401, the control unit 400 acquires the value of the transfer destination device number input form 1304, and proceeds to S1402. At this time, the control unit 400 generates the transfer license issuance screen 1310 in the RAM 205 and the like.

In S1402, the license information management unit 408, with reference to the license management table 650, confirms the status of issuance of license to the MFP retaining the transfer source device number acquired in S1401. Specifically, the license information management unit 408, with reference to the value of the device number column 653 of the respective data registered in the license management table 650, confirms if there is data corresponding to the transfer source device number 1303. If it is determined that there is corresponding data, the license information management unit 408 determines that license is issued to the transfer source device (“Yes” in S1402). In this case, the processes of S1403 to S1409 are executed. The processes of S1403 to S1409 are executed as many times as the number of the data, present in the license management table 650, of which the value of the device number column 653 corresponds to the transfer source device number 1303.

On the other hand, if there is no data in the license management table 650 of which the value of the device number column 653 corresponds to the transfer source device number 1303, or the processes of S1403 to S1409 have been executed for all of the corresponding data, the license information management unit 408 determines “No” in S1402. In this case, the transmission unit 402 transmits the transfer license issuance screen 1310 to the PC 103, and the process ends.

In S1403, the license information management unit 408 acquires one item of license information of which the value of the device number column 653 corresponds to the transfer source device number 1303 (hereafter “current license information”).

In S1404, the license information management unit 408 acquires the value of the license number column 652 of the current license information. If the value is a license number that has already been processed, while not illustrated, the process transitions to S1402 to move the process to the next license information. The license information management unit 408 also references the value of the license number column 641 of the respective data registered in the license number management table 640, and acquires license number information that agrees with the value of the license number column 652. Then, the license information management unit 408 references the value of the complex merchandise ID column 643 of the acquired license number information. If a value is stored in the complex merchandise ID column 643, the license information management unit 408 determines that the merchandise is a MFP software merchandise configured as a complex merchandise. In this case, the license information management unit 408 determines that the current license information is that of complex merchandise license (“Yes” in S1404), and proceeds to S1405.

On the other hand, if a value is stored in the complex merchandise ID column 643, the license information management unit 408 determines that the merchandise is a MFP software merchandise configured as a single-item merchandise. In this case, the license information management unit 408 determines that the current license information is that of single-item merchandise license (“No” in S1404), and proceeds to S1409.

In S1405, the merchandise information management unit 407, with reference to the value of the complex merchandise ID column 631 of the respective data registered in the complex merchandise information management table 630, acquires complex merchandise information that agrees with the value of the complex merchandise ID column 643 referenced in S1404. The merchandise information management unit 407 then acquires the value of the merchandise ID column 633 of the acquired complex merchandise information. Further, the merchandise information management unit 407, with reference to the value of the merchandise ID column 621 of the respective data registered in the merchandise information management table 620, acquires all of the merchandise information that agree with the value of the merchandise ID column 633.

Then, in S1406, the software information management unit 406, with reference to the value of the software ID column 611 of the respective data registered in the software information management table 610, acquires all of the software information that agree with the value of the software ID column 623 acquired in S1405. Finally, the software information management unit 406, with reference to the value of the transferability column 613 of all of the acquired software information, confirms if there is data with the value “No”. If there is even one piece of data with the value “No” of the transferability column 613, the software information management unit 406 determines that the complex merchandise is a merchandise that includes a transfer-prohibited software merchandise as a constituent element (“Yes” in S1406). In this case, the software information management unit 406 proceeds to S1407.

On the other hand, if there is not even one piece of data with the value “No” of the transferability column 613, the software information management unit 406 determines that the complex merchandise is a merchandise that does not include a transfer-prohibited software merchandise as a constituent element (“No” in S1406). In this case, the software information management unit 406 proceeds to S1410.

In S1407, the license issuance determination unit 403 displays, in the registration status display area 1319 corresponding to the current license information in the transfer license issuance screen 1310, a message indicating that the license corresponding to the current license information is transfer-prohibited (transfer prohibition message). Upon completion of the process of S1407, the process proceeds to S1408.

In S1409, the merchandise information management unit 407, with reference to the value of the merchandise ID column 621 of the respective data registered in the merchandise information management table 620, acquires merchandise information that agrees with the value of the merchandise ID column 642 of the license number information corresponding to the current license information acquired in S1404. Upon completion of the process of S1409, the process proceeds to S1410.

In S1410, the license issuance determination unit 403 displays, in the registration status display area 1319 corresponding to the current license information in the transfer license issuance screen 1310, a message indicating that invalidation license for transfer is not registered and the invalidation license for transfer registration button 1320. Upon completion of the process of S1410, the process proceeds to S1408.

In S1408, the license issuance determination unit 403 stores, in the items of the installed merchandise display area 1322 of the transfer license issuance screen 1310 corresponding to the current license information, values related to the current license information acquired in S1403.

Specifically, when the merchandise information corresponding to the current license information indicates a single-item merchandise or an integrated merchandise that does not include a transfer-prohibited software merchandise, the license issuance determination unit 403 displays the transfer object merchandise selection check box 1314. In accordance with the result of S1404, the license issuance determination unit 403 displays the value “single-item merchandise” or “complex merchandise” in the merchandise class display area 1315. The license issuance determination unit 403 further displays, in the merchandise name display area 1316, the merchandise name of the merchandise information corresponding to the current license information. If the merchandise information indicates a single-item merchandise, the value of the corresponding merchandise name column 622 is displayed. If the merchandise information indicates a complex merchandise, the value of the merchandise name column 622 of the merchandise information of all of the merchandise IDs stored in the corresponding merchandise ID column 633 is displayed. If the merchandise has been determined to be a complex merchandise in S1404, the license issuance determination unit 403 displays the value of the complex merchandise name column 632 in the complex merchandise name display area 1317. Upon completion of the process of S1408, the process transitions to S1402 and moves to the next license information.

By the above process, when the license management server 102 displays the license transfer screen, the merchandise information as the object of issuance of transfer license is distinguished and, with respect to a complex merchandise including transfer-prohibited software merchandise information, screen control is implemented such that transfer license cannot be issued while the user is notified. By implementing such control, the user can be alerted so that a redundant operation or an erroneous operation is not performed, while disabling such operations.

Finally, the issuance of transfer license by the license management server 102 will be described. The license management server 102, upon reception from the PC 103 the value of the transfer destination device number display area 1313 and a transfer license issuance request including a invalidation license for transfer file registered with the registration button 1320, issues a transfer license. First, the reception unit 401 of the license management server 102 extracts, from the invalidation license for transfer in the transfer license issuance request, a license ID, a software ID, and a device number. Further, the license information management unit 408 identifies the license information of which the license ID, software ID, and device number respectively agree with the license ID 651, the software ID 654, and the device number 653, and rewrites the device number of the license information to the transfer destination device number included in the transfer license issuance request. At this time, a license may be newly issued and the license ID column 651 may be rewritten with the corresponding license ID. The license issuance unit 404 then issues the license 800 or 810 based on the license information of the rewritten license management table 650. Thus, the transfer license corresponding to the transfer license issuance request (with the same configuration as the license 800) is stored in the secondary storage device 206 of the license management server 102 as a license file. Finally, the transmission unit 402 of the license management server 102 transmits a screen similar to the license download screen 1510 to the PC 103 as the transfer license issuance request source, and ends the series of license transfer processes. When the download button on the screen is depressed, the created license 800 or 810 is downloaded to the PC 103. The transfer license is installable in a device designated as a transfer destination, as in the case of normal license.

### Second Exemplary Embodiment

In the first exemplary embodiment, with respect to the license for a complex merchandise including a transfer-prohibited software merchandise, the licensing operation is prevented in both the MFP 104 and the license management server 102, whereby the user can be prevented from making a redundant operation or an erroneous operation. However, when the MFP needs to be replaced during use due to MFP failure, for example, in order to allow the complex merchandise being used prior to replacement to be continuously used in the MFP after replacement, the license number and license need to be issued from the license management server again. Thus, the user of the MFP needs to continuously manage a plurality of license numbers even though the MFP software that is used remains unchanged, the work involved being complicated and stressing to the user of the MFP 104.

In the second exemplary embodiment, a license managing method will be described that enables issuance of license for the MFP after replacement with the license number for the MFP before replacement, without newly issuing the license number. In the following, description of the same configurations as those of the first exemplary embodiment will be omitted, and only different portions will be described.

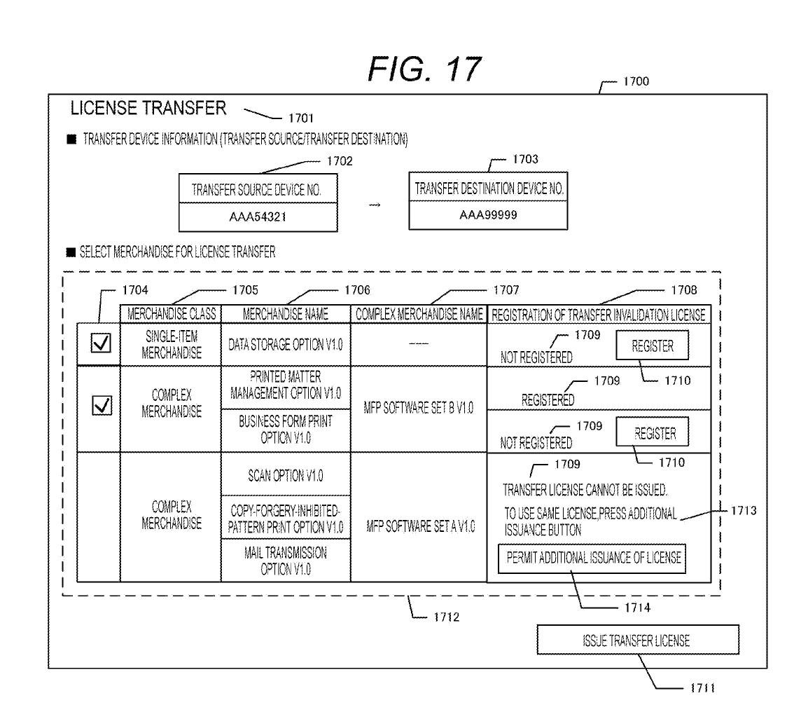

FIG. 17 is a diagram illustrating a transfer license issuance screen 1700 according to the second exemplary embodiment.

The transfer license issuance screen 1700 according to the second exemplary embodiment is the transfer license issuance screen 1310 according to the first exemplary embodiment shown in FIGS. 15A and 15B which is additionally provided with a button for enabling the issuance of additional license with respect to the complex merchandise for which issuance of transfer license is prohibited.

In FIG. 17, description of constituent elements 1701 to 1712 will be omitted as they are similar to the constituent elements 1311 to 1322 in FIGS. 15A and 15B.

A license additional issuance permission message display area 1713 is an area for displaying a message notifying the operator of the PC 103 that additional issuance of license is permitted for the merchandise information.

A license additional issuance permission button 1714 is a button for receiving from the operator of the PC 103 whether the additional issuance of license for a corresponding complex merchandise is to be permitted to the user of the MFP 104. The license additional issuance permission button 1714 is a button which is displayed only when a transfer-prohibited software merchandise is included in the corresponding complex merchandise. Namely, the license additional issuance permission button 1714 is an instruction unit for requesting the license management server 102 for permission for the additional issuance of license using the license number associated with the software license belonging to a complex merchandise including a transfer-prohibited software merchandise. Specifically, the button 1714 is displayed in the case of a complex merchandise that includes, in a part thereof, the merchandise information of MFP software of which the value of the transferability column 613 of the software information is “No”. The message in the license additional issuance permission message display area 1713 and the license additional issuance permission button 1714 are displayed by the license issuance determination unit 403 in S1407 of FIG. 16.

When the operator of the PC 103 depresses the license additional issuance permission button 1714, the license management server 102 is notified. In response to the notice, the license management server 102 modifies the value of an additional issuance permission column 1805 of a license number management table 1800, which will be described later, to “Yes”, with respect to the license number corresponding to the complex merchandise corresponding to the depressed license additional issuance permission button 1714 (details will be described later). In this state, the license management server 102, upon reception of a license issuing request corresponding to the license number, is enabled to issue additional license even if the license number is a license number of which license is already issued (details will be described later).

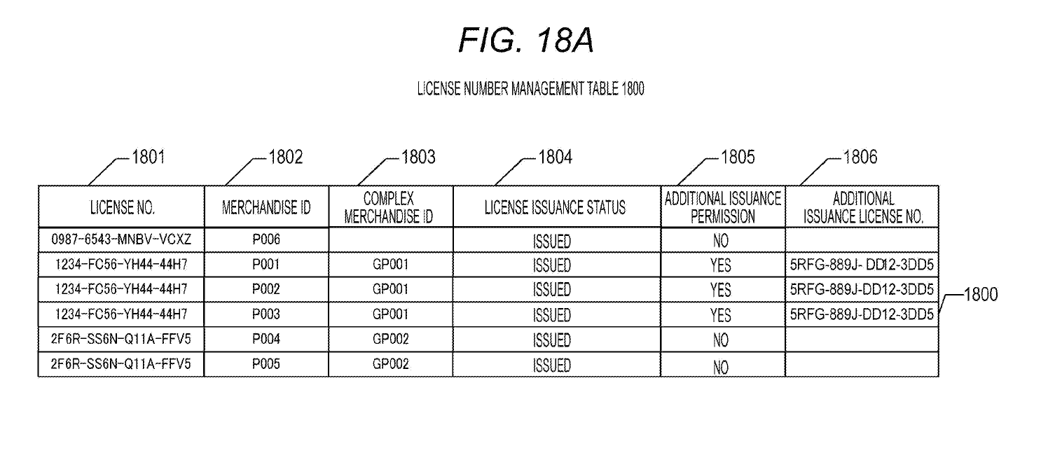

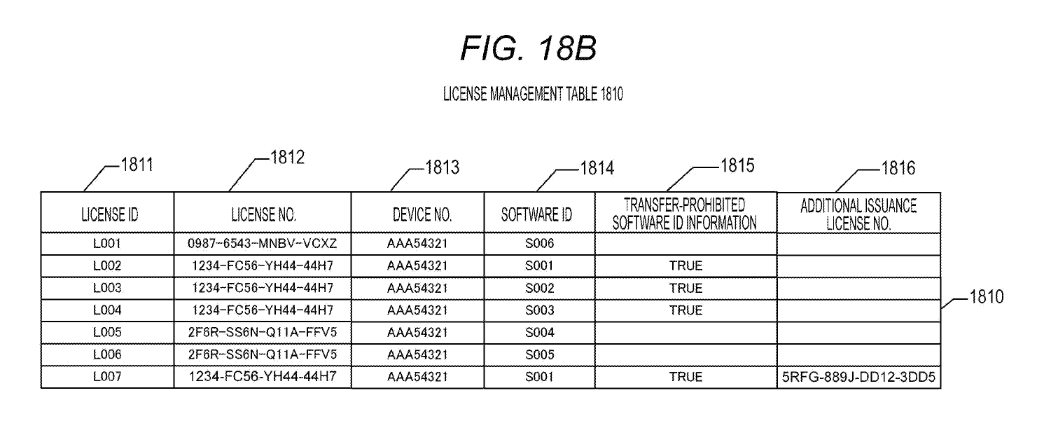

FIGS. 18A and 18B are diagrams illustrating the data structure, in table format, of the license number information managed in the license information management unit 408 of the license management server 102 and license information according to the second exemplary embodiment.

The license number management table 1800 according to the second exemplary embodiment is a table for managing information of the license number in the license information management unit 408. The license number is information issued by the license management server 102. Description of constituent elements 1801 to 1804 in the license number management table 1800 will be omitted as they are similar to the constituent elements 641 to 644 of the license number management table 640 according to the first exemplary embodiment shown in FIGS. 6A to 6F.

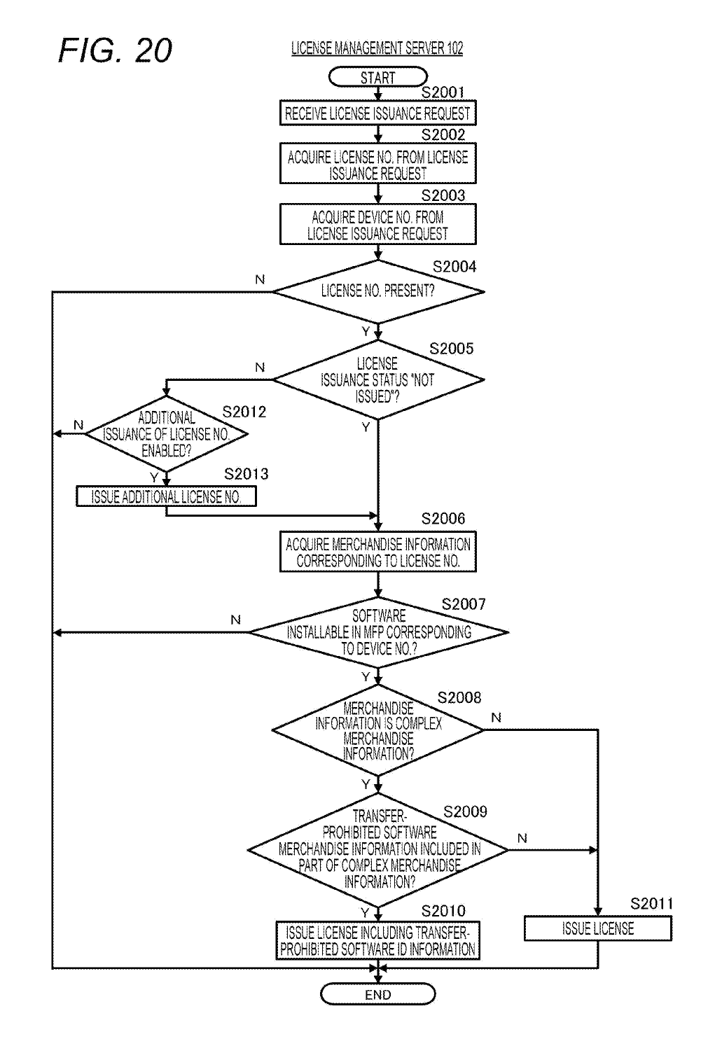

An additional issuance permission column 1805 is a column storing the value as to whether additional issuance of license is permitted by the license management server 102 with respect to a license number of which the value of the license issuing status column 1804 is “issued”. The initial value upon issuance of a license number by the license management server 102 is “No”. Only when the license additional issuance permission button 1714 shown in FIG. 17 is depressed by the operator of the PC 103, the “Yes” is stored in the additional issuance permission column 1805. In a series of license issuance processes using an additional issuance license number as will be described below with reference to FIG. 20, when a license is issued with an additional issuance license number, the value “No” is again stored in the additional issuance permission column 1805.

An additional issuance license number column 1806 is a column storing the value of the additional issuance license number issued by the license management server 102 when the value of the additional issuance permission column 1805 is “Yes”. A series of processes in which the license management server 102 issues the additional issuance license number will be described with reference to FIG. 20.

A license management table 1810 according to the second exemplary embodiment is a table for managing information of the license issued by the license management server 102 in the license information management unit 408. Description of constituent elements 1811 to 1815 of the license management table 1810 according to the second exemplary embodiment will be omitted as they are similar to the constituent elements 651 to 655 of the license management table 650 according to the first exemplary embodiment shown in FIGS. 6A to 6F.

An additional issuance license number column 1816 is a column storing an additional issuance license number when a license is issued with the additional issuance license number in a series of processes for issuing license in the license management server 102 as will be described with reference to FIG. 20.

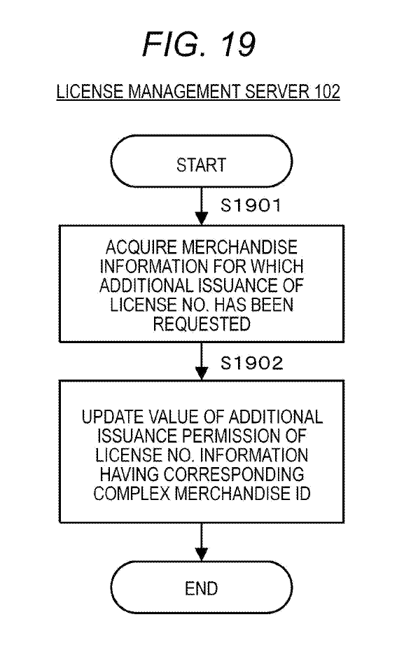

FIG. 19 is a flowchart illustrating a series of processes in which, in accordance with the operation of the license additional issuance permission button 1714 by the operator of the PC 103, the license management server 102 permits additional issuance of a license for a complex merchandise. The processes of the flowchart are realized by the CPU 203 of the license management server 102 reading a program stored in the secondary storage device 206 and executing the program.

The software information management unit 406 of the license management server 102, upon reception of a notice from the PC 103 that the license additional issuance permission button 1714 has been depressed, proceeds to S1901. In S1901, the software information management unit 406 acquires, from the merchandise information being displayed on the transfer license issuance screen 1700, complex merchandise information corresponding to the depressed license additional issuance permission button 1714. Specifically, from the merchandise information of the license issued by the license management server 102 to the MFP 104 of the device number displayed in the transfer source device number display area 1702, the value of the license number column 1812 corresponding to the depressed license additional issuance permission button 1714 is acquired. Then, the software information management unit 406, with reference to the license number management table 1800, acquires all of license number information including the license number column 1801 of which the value agrees with the acquired license number column 1812.

Next, in S1902, the software information management unit 406 confirms the value of the complex merchandise ID column 1803 with respect to all of the license number information data acquired in S1901. When a value is stored in the complex merchandise ID column 1803, the software information management unit 406 stores “Yes” in the value of the additional issuance permission column 1805 of the corresponding data. By the above process, it becomes possible to issue additional license using the license number corresponding to the complex merchandise of the depressed license additional issuance permission button 1714.

FIG. 20 is a flowchart illustrating a series of processes for issuing license for a complex merchandise including a MFP software merchandise for which device-to-device transfer is prohibited in the license management server 102 according to the second exemplary embodiment. The processes of the flowchart are realized by the CPU 203 of the license management server 102 reading a program stored in the secondary storage device 206 and executing the program. The series of processes of the present flowchart will be described as being performed between the license management server 102 and the PC 103 connected via the Internet 100. However, a similar operation may also be performed between the license management server 102 and the MFP 104 connected via the Internet 100.

The processes of FIG. 20 are the processes of FIG. 10 to which a series of processes is added for issuing, with an additional issuance license number, license for a complex merchandise including a MFP software merchandise for which device-to-device transfer is prohibited. Description of processes S2001 to S2004 in FIG. 20 will be omitted as they are similar to the processes S901 to S904 of the first exemplary embodiment shown in FIG. 10.

In S2005, the license issuance determination unit 403 confirms the value of the license issuing status column 1804 of the data found to be corresponding in S2004. If it is determined that the value of the license issuing status column 1804 is “not issued” (“Yes” in S2005), the license issuance determination unit 403 proceeds to S2006. On the other hand, if it is determined that the value of the license issuing status column 1804 is “issued” (“No” in S2005), the license issuance determination unit 403 proceeds to S2012.

In S2012, the license issuance determination unit 403 confirms the value of the additional issuance permission column 1805 of the data found to be corresponding in S2004. If the value of the additional issuance permission column 1805 is “No”, the license issuance determination unit 403 determines that the additional issuance of license number is not enabled (“No” in S2012), and that a license cannot be issued. Then, the transmission unit 402 of the license management server 102 transmits to the user interface 201 of the PC 103 a screen (not shown) indicating failure in issuance of license, and ends the series of license issuance processes.

On the other hand, if the value of the additional issuance permission column 1805 is “Yes”, the license issuance determination unit 403 determines that the additional issuance of a license number is enabled (“Yes” in S2012), and proceeds to S2013.

In S2013, the license issuance unit 404 issues an additional issuance license number. Then, in the license number management table 1800, the license issuance unit 404 stores the issued additional issuance license number in the additional issuance license number column 1806 of the license number information of which the value of the license number column 1801 agrees with the license number acquired in S2002. Further, the license issuance unit 404 sets the value of the additional issuance permission column 1805 of the license number information to “No”. Upon completion of the process of S2013, the process proceeds to S2006. Description of processes of S2006 to S2009 and 2011 in FIG. 20 will be omitted as they are similar to the processes S906 to S909 and 911 of the first exemplary embodiment shown in FIG. 10.

In S2010, the license issuance unit 404 issues the license 810. First, the license information management unit 408 stores the license information corresponding to the license number 1503 respectively in the license management table 1810. Specifically, the license information management unit 408 generates a value that can uniquely identify the license information registered in the license management table 1810, and stores the value in the license ID column 1811. Normally, sequential values are registered in ascending order in order of registration of the license information. Further, the license information management unit 408 stores the value of the license number 1503 in the license number column 1812. The license information management unit 408 also stores the value of the device number 1504 in the device number column 1813. The license information management unit 408 also stores in the software ID column 1814 the value of the software ID column 623 of the merchandise information acquired in S2006. Further, the license information management unit 408 stores the value “TRUE” in the transfer-prohibited software identification information column 1815. If an additional issuance license number is issued in S2013, the license information management unit 408 stores in the additional issuance license number column 1816 the value of the additional issuance license number column 1806 corresponding to the license number 1503. Then, the license issuance unit 404 issues the license 810 based on the license information stored in the license management table 1810. Thus, the license 810 corresponding to the license issuing request received in S2001 is stored in the secondary storage device 206 of the license management server 102 as a license file. Also, the license information management unit 408 references the license number management table 1800 and stores the value “issued” in the license issuing status column 1804 of the license number information of which the value of the license number column 1801 agrees with the license number 1503. Finally, the transmission unit 402 of the license management server 102 transmits the license download screen 1510 to the PC 103 and ends the series of license issuance processes. When the download button 1514 of the license download screen 1510 is depressed, the additionally created license 810 is downloaded to the PC 103.

As described above, the license management server 102 issues an additional issuance license number to a license number for which a license is already issued, whereby the operator of the PC 103 can be granted the issuance of new license with the license number that the user has been previously using. The license management server 102, by using the additional issuance license number as a license number associated with the license information, can properly manage the issued license and the license number corresponding to the license.

In the configuration according to the second exemplary embodiment, the additional license is made issuable with respect to a license for a complex merchandise including a MFP software merchandise for which device-to-device transfer is prohibited. However, an additional license may be made similarly issuable even in the case of a device-to-device transfer enabled MFP software merchandise if the invalidation license for transfer cannot be issued due to MFP failure and the like.

The message in the license additional issuance permission message display area 1713 and the license additional issuance permission button 1714 may be displayed only when a license transfer screen display request is made by an administrator and the like who have logged in with special rights.

In the foregoing exemplary embodiments, management of license of an application installed in an image forming device, such as MFP, has been described. However, the software of which license can be managed by the present invention is not limited to an application installed in an image forming device. Any software license installed in information processing devices such as a personal computer and various electronic devices in which software is installable can be similarly managed. The software is not limited to programs, and the license managing method according to the present invention can be applied to any electronic information.

Thus, according to the present invention, when an MFP software license for a complex merchandise including transfer-prohibited software is installed in an MFP, a license transfer operation for MFP software of the relevant complex merchandise on the MFP is prohibited. In this configuration, the user can be notified beforehand whether license transfer is enabled and the license transfer can be prohibited with respect to the license for a complex merchandise having both a license transfer-enabled application and a license transfer-disabled application. Accordingly, the user can be prevented from executing a useless operation with respect to the license of an application for which a license transfer operation cannot be executed.

It should be obvious that the configuration and content of the various data described above are not limited to the above examples, and that various other configurations or contents may be used in accordance with particular uses or purposes.

While an embodiment has been described above, the present invention may be implemented in various modes, such as, for example, in the form of a system, a device, a method, a program, or a storage medium. Specifically, the present invention may be applied to a system including a plurality of devices, or to a device consisting of a single device.

All configurations combining the various exemplary embodiments are also included in the present invention.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-081670, filed Apr. 11, 2014, which is hereby incorporated by reference herein in its entirety.

What is claimed is:

1. A management system comprising a management server that manages software license utilizable in an information processing device, and one or more information processing devices, wherein:
the management server includes
an issuing unit that issues the software license to a designated information processing device, and
a managing unit that manages the license issued by the issuing unit in association with the designated information processing device;
the issuing unit issues the license to which transfer prohibition information is attached indicating that movement of license to another information processing device is prohibited when the software as the object of issuance of license is software for which movement of license to the other information processing device is prohibited, or which is in dependence relationship with the software for which movement of license to the other information processing device is prohibited; and
the information processing device includes
a utilizing unit that makes the software utilizable using the license issued in the management server, and
a generating unit that invalidates the license on the information processing device and generates invalidation information indicating that the license is invalidated as a process for moving the license used for utilization of the software from the information processing device to the other information processing device, and a prohibiting unit that prohibits the process by the generating unit with respect to the license to which the transfer prohibition information is attached.

2. The management system according to claim 1, wherein the issuing unit issues, in response to a movement request including the invalidation information, a license corresponding to the invalidation information with respect to an information processing device designated as a movement destination.

3. The management system according to claim 2, wherein the management server includes
a providing unit that provides a screen for generating the movement request for moving the license managed by the managing unit in association with the designated information processing device to the other information processing device, wherein
the screen provided by the providing unit is a screen such that the movement request cannot be generated with respect to the license corresponding to software for which movement of license to the other information processing device is prohibited or which is in dependence relationship with the software for which movement of license to the other information processing device is prohibited.

4. The management system according to claim 3, wherein:
the issuing unit issues the license in accordance with a license number for issuing the license;
the managing unit manages whether the license is already issued based on the license number; and
the screen provided by the providing unit includes an instruction unit for requesting the management server for permission for additional issuance of license using the license number managed in association with the license with respect to a license corresponding to software for which movement of license to the other information processing device is prohibited or which is in dependence relationship with the software for which movement of license to the other information processing device is prohibited,
the system further comprising a permission unit that permits the additional issuance of license using the license number corresponding to the request in response to the request by the instruction unit for permission for the additional issuance of license,
the issuing unit being configured to issue, upon request for the issuance of license corresponding to the license number being managed by the managing unit as having been issued with license, a new license number in association with the license number and a license in accordance with the new license number if the additional issuance of license for the license number is permitted by the permission unit.

5. The management system according to claim 1, wherein the managing unit is also configured to manage information indicating whether movement of license for each item of software to the other information processing device is prohibited, and a dependence relationship of respective software items.

6. The management system according to claim 5, wherein the software items having the dependence relationship are software items included in the same merchandise.

7. The management system according to claim 1, wherein the information processing device is an image forming device.

8. A method of controlling a management system including a management server that manages software license utilizable in an information processing device, and one or more information processing devices, the method comprising:
the management server executing
an issuing step of issuing a software license for a designated information processing device, and
a managing step of managing the license issued in the issuing step in association with the designated information processing device,
the issuing step including issuing the license to which transfer prohibition information is attached indicating that movement of the license to another information processing device is prohibited when the software as the object of issuance of license is software for which movement of license to the other information processing device is prohibited or which is in dependence relationship with the software for which movement of license to the other information processing device is prohibited; and
the information processing device executing
a step of making the software utilizable using the license issued in the management server,
a generating step of invalidating the license on the information processing device and issuing/generating invalidation information indicating that the license is invalidated as a process for moving the license used for utilization of the software from the information processing device to the other information processing device, and
a prohibiting step of prohibiting the process of the generating step with respect to the license to which the transfer prohibition information is attached.

9. A management server that manages software license utilizable in an information processing device, the management server comprising:
an issuing unit that issues a software license to a designated information processing device; and
a managing unit that manages the license issued by the issuing unit in association with the designated information processing device, wherein
the issuing unit, when the software as the object of issuance of license is software for which movement of license to another information processing device is prohibited or which is in dependence relationship with the software for which movement of license to the other information processing device is prohibited, issues the license to which transfer prohibition information indicating that movement of license to the other information processing device is prohibited is attached.
